(19) United States
(12) Patent Application Publication
(10) Pub. No.: US 2025/0323350 A1
(43) Pub. Date: Oct. 16, 2025

(54) CELL BIASING METHODS FOR A BATTERY

(71) Applicant: LITENS AUTOMOTIVE PARTNERSHIP, Woodbridge (CA)

(72) Inventors: John R ANTCHAK, Aurora (CA); Sean KIERAN, Woodbridge (CA); Andrew Malcolm BOYES, Aurora (CA); Geoffrey William RYELAND, North York (CA); David NAKHLA, Ancaster (CA)

(21) Appl. No.: 18/870,494

(22) PCT Filed: Jun. 28, 2023
(86) PCT No.: PCT/CA2023/050893

§ 371 Date: Nov. 29, 2024

Related U.S. Application Data
(60) Provisional application No. 63/367,182, filed on Jun. 28, 2022.
(60) Provisional application No. 63/367,185, filed on Jun. 28, 2022.
(60) Provisional application No. 63/444,173, filed on Feb. 8, 2023.
(60) Provisional application No. 63/463,015, filed on Apr. 29, 2023.
(60) Provisional application No. 63/463,298, filed on May 1, 2023.

(51) Int. Cl. H01M 10/6569; B60L 50/64; B60L 58/26; H01M 10/42; H01M 10/613; H01M 10/625; H01M 10/643; H01M 50/213; H01M 50/249; H01M 50/296

(52) U.S. Cl. CPC H01M 10/6569; H01M 10/425; H01M 10/613; H01M 10/625; H01M 10/643; H01M 50/213; H01M 50/249; H01M 50/296; B60L 50/64; B60L 58/26; H01M 2220/20

(57) ABSTRACT

A battery pack is provided and includes a battery pack housing defining a pair of side walls. and a plurality of modules positioned in the battery pack housing in a row along the side walls. Each of the modules includes a module housing that extends between the side walls. Each of modules contains a first plurality of cells that are all electrically connected to one another. and a second plurality of cells that are all electrically connected to one another, and which are electrically isolated from the first plurality of cells. Cell biasing members bias the cells toward the busbar for improved connectivity and tension rods prevent deformation of the modules from thermal expansion.

### CROSS-REFERENCE TO RELATED APPLICATIONS

This application is a divisional application of U.S. provisional patent application No. 63/367,185 filed on Jun. 28, 2022, U.S. provisional patent application No. 63/367,182 filed on Jun. 28, 2022, U.S. provisional patent application no. 63/444, 173 filed on Feb. 8, 2023, U.S. provisional patent application No. 63/463,015 filed on Apr. 29, 2023, and U.S. provisional patent application No. 63/463,298 filed on May 1, 2023, the entire contents of all of which are incorporated by reference in this application, where permitted.

### FIELD OF THE INVENTION

The specification relates generally to battery packs, and more particularly to battery packs having cells that are immersion-cooled, optionally for electric vehicles or for other applications such as in a stationary setting for power storage and consumption.

### BACKGROUND OF THE INVENTION

Battery packs and for electric vehicles and for other applications such as stationary application, suffer from numerous problems. Some packs can experience thermal runaway, which endangers any persons nearby. Some packs are difficult to manufacture and difficult or practically impossible to disassemble in a way that permits use of the cells contained therein for another purpose or for replacement of any cells. Some packs are relatively heavy, and have low cell densities. Other problems also exist. An improved battery pack is desirable.

### Summary of the Disclosure

In an aspect, the disclosure is directed to a module for a battery pack, comprising: a module housing and a plurality of cells, wherein the module housing includes a first module housing member and a second module housing member, wherein the module housing defines a cell chamber for holding the plurality of cells and a quantity of a cooling fluid, wherein the second module housing member has a plurality of tension rod apertures therethrough; a plurality of bus bars in the housing that connect the cells electrically in a combination of series and parallel electrical connections; at least one cell biasing member that is positioned to urge the cells and the bus bars into engagement with one another with at least a selected engagement force; and a plurality of tension rods, wherein each tension rod from the plurality of tension rods has a first end and a second end, and wherein the first end has a first connection with a first end member engaged with the first module housing member, and wherein the second end has a second connection with a second end member engaged with the second module housing member, such that the first and second end members apply a selected clamping force on the first and second module housing members, wherein at least one of the first and second connections is a threaded connection, such that the second end member is rotatable by a tool until a selected torque is reached, which is indicative that any of the plurality of cells that are proximate the tension rod are engaged with one another with at least the selected engagement force.

In another aspect, the disclosure is directed to a module for a battery pack, comprising: a module housing; a plurality of cells positioned in the module housing each of the cells including a positive terminal and a negative terminal; a bus bar that electrically connects the positive terminals on a first subset of cells from the plurality of cells and the negative terminals on a second subset of cells from the plurality of cells; a cell biasing member positioned in engagement with all of one of the first and second subsets of cells separately from the bus bar and which electrically connects in parallel to the negative terminals of said all of one of the first and second subsets of cells, wherein the cell biasing member urges said all of one of the first and second subsets of cells towards the bus bar.

In yet another aspect, the disclosure is directed to a module for a battery pack, comprising: a module housing and a plurality of cells, wherein the module housing includes a first module housing member and a second module housing member, wherein the module housing defines a cell chamber for holding the plurality of cells and a quantity of a cooling fluid, wherein the second module housing member has a plurality of tension rod apertures therethrough; a plurality of bus bars in the housing that connect the cells electrically in a combination of series and parallel electrical connections; at least one biasing member that is positioned to apply a biasing force to urge the cells and the bus bars into engagement with one another with at least a selected engagement force; and wherein the plurality of biasing members extend over a range of values between a low height value and a high height value, wherein the low and high height values depend at least in part on tolerances in the cell heights of the cells, and wherein the biasing force varies between a low biasing force at one of the low height value and the high height value, and a high biasing force at the other of the low height value and the high height value, and wherein a ratio of the low biasing force to the high biasing force is less than the ratio of the low height value to the high height value.

In another aspect, the disclosure is directed to a module for a battery pack, comprising: a module housing defining a sealed fluid-holding space for holding a quantity of a cooling fluid; a plurality of cells positioned in the module housing each of the cells including a positive terminal and a negative terminal; a bus bar in the fluid-holding space, wherein the bus bar electrically connects the positive terminals on a first subset of cells from the plurality of cells and the negative terminals on a second subset of cells from the plurality of cells; a voltage tap in engagement with the bus bar, wherein the voltage tap is molded into the housing; and a module controller that is mounted to an exterior of the module housing, wherein the voltage tap is engaged with the module controller to send signals thereto.

In yet another aspect, the disclosure is directed to a battery pack, comprising: a battery pack housing; a plurality of modules positioned in the battery pack housing and horizontally spaced apart, wherein each of the modules includes a module housing that defines a coolant-holding space for holding a quantity of coolant, and a plurality of cells positioned in the module housing; a coolant supply line in fluid communication with a coolant source and the coolant-holding spaces of at least two of the modules; wherein the coolant supply line is in fluid communication with the at least two of the modules in parallel; and wherein the coolant supply line is contained in the battery pack housing, external to the module housings, and connected to a top side of the module housings of the at least two modules.

In yet another aspect, the disclosure is directed to a bus bar for a battery module comprising a cell having a cell terminal, the bus bar comprising: a first contact surface for contacting the cell terminal, wherein the contact surface is textured (e.g., dimpled, grooved) to define: a first upper portion; a second upper portion; and a lower portion; wherein the lower portion is disposed horizontally between and connects the upper portions; wherein the upper portions are disposed above the lower portion by a first vertical distance of between (h-min: which may be, for example, 0.3 mm) and a second vertical distance that is larger than the first vertical distance (h-max); and wherein the upper portions are separated by a first horizontal dimension of between (w-min: which may be, for example, 1.0 mm) and a second horizontal dimension (w-max) that is larger than the first horizontal dimension.

In yet another aspect, the disclosure is directed to a method of operating a battery pack comprising a module comprising a module housing comprising first and second module housing members and containing bus bars in contact with a plurality of cells, the method comprising: regulating a temperature of the plurality of cells using a cooling liquid that flows through the module housing and in which the plurality of cells is immersed; charging or discharging the battery pack using at a rate of at least 2 C; removing one or more of the plurality of cells from the battery pack by removing the second module housing member from the first housing member to disengage the bus bars from the plurality cells and thereby electrically disconnect the plurality of cells from each other; and replacing the one or more removed cells with one or more replacement cells.

In yet another aspect, the disclosure is directed to a battery pack, comprising: a battery pack housing defining a pair of side walls; and a plurality of modules positioned in the battery pack housing in a row along the side walls, wherein each of the modules includes a module housing that extends between the side walls; wherein each of modules contains a first plurality of cells that are all electrically connected to one another, and a second plurality of cells that are all electrically connected to one another, and which are electrically isolated from the first plurality of cells.

In yet another aspect, the disclosure is directed to a battery pack, comprising: a battery pack housing; a plurality of modules positioned in the battery pack housing, wherein each of the modules includes a module housing that defines a cell chamber that contains a plurality of cells, and has an upper surface that defines at least one module housing cooling fluid inlet; a coolant supply hose in fluid communication with a cooling fluid source and the module housing cooling fluid inlets of at least two of the modules in parallel; and wherein the coolant supply hose is contained in the battery pack housing, external to the module housings.

In yet another aspect, the disclosure is directed to a bus bar for a battery module comprising a cell having a cell terminal, the bus bar comprising: a contact surface for contacting the cell terminal, wherein the contact surface is textured to define a plurality of contact surface portions, and a plurality of recesses between adjacent ones of the contact surface portions, wherein the recesses have a depth from the contact surface portions of at least 0.2 millimeters and a width of at least 0.2 millimeters.

In yet another aspect, the disclosure is directed to a battery pack system for an electric vehicle, comprising: a plurality of battery packs, wherein each battery pack includes a plurality of cells for storing charge for powering a traction motor of the electric vehicle; a thermal management system for the plurality of battery packs that transports a cooling fluid through the battery packs; a plurality of valves that control a flow of the cooling fluid to each of the battery packs; a control system that is operatively connected to the valves to control operation of the valves so as to control the flow of the cooling fluid to each of the battery packs; at least one sensor in each of the battery packs that sends signals to the control system, wherein the signals are indicative of whether any of the cells in any of the battery packs are at risk of thermal runaway; wherein the control system includes a processor and a memory that contains program code that is executable to operate the plurality of valves to increase flow of the cooling fluid to one of the battery packs and to decrease flow of the cooling fluid to the other battery packs, based on the signals, in order to inhibit thermal runaway.

In another aspect, the disclosure is directed to a battery pack system for an electric vehicle, comprising: a first battery pack and a second battery pack, wherein each of the first and second battery packs includes a plurality of cells for storing charge for powering a traction motor of the electric vehicle; a thermal management system for the first and second battery packs that transports a cooling fluid through the first and second battery packs; a plurality of valves that control a flow of the cooling fluid to each of the first and second battery packs; a control system that is operatively connected to the valves to control operation of the valves so as to control the flow of the cooling fluid to each of the first and second battery packs; a sensor arrangement that sends signals to the control system, wherein the signals are indicative of whether any of the plurality of cells in the first battery pack are at risk of thermal runaway, and whether any of the plurality of cells in the second battery pack are at risk of thermal runaway; wherein the control system includes a processor and a memory and wherein the memory contains program code executable by the processor to: a) determine whether the first battery pack is at risk of thermal runaway based on the signals; b) determine whether the second battery pack is at risk of thermal runaway based on the signals; c) operate the plurality of valves to increase flow of the cooling fluid to the first battery pack and to decrease flow of the cooling fluid to the second battery pack based on determining in steps a) and b) that the first battery pack is at risk of thermal runaway and that the second battery pack is not at risk of thermal runaway; and d) operate the plurality of valves to increase flow of the cooling fluid to the first battery pack and to decrease flow of the cooling fluid to the second battery pack based on determining in steps a) and b) that the first battery pack is at risk of thermal runaway and that the second battery pack is not at risk of thermal runaway.

### BRIEF DESCRIPTION OF THE DRAWINGS

For a better understanding of the embodiment(s) described herein and to show more clearly how the embodiment(s) may be carried into effect, reference will now be made, by way of example only, to the accompanying drawings.

FIG. 1 shows an electric vehicle with a battery pack connected to a charging station.

FIG. 2 is a perspective view of an embodiment of a battery pack of the present disclosure.

FIG. 3 is a perspective view of the battery pack of FIG. 2 with the top battery pack housing member separated from the remainder of the battery pack.

FIG. 4 is a schematic depiction of the electrical connection of pluralities of cells of a plurality of modules in the battery pack of FIG. 2.

FIG. 5 is a perspective view of a module of the battery pack of FIG. 2, with the cooling fluid inlet and outlet hoses, CMUs, and associated cables removed.

FIG. 6 is a sectional perspective view of part of the module along section line A-A of FIG. 5.

FIG. 7 is a sectional perspective view of part of the module along section line B-B of FIG. 5.

FIG. 8 is a schematic depiction of the cooling fluid supply and return hoses of the modules in the battery pack of FIG. 2.

FIG. 9 is a perspective view of a bottom side of an embodiment of a negative bus bar terminal of a bus bar of the battery pack of FIG. 2.

FIG. 10 is a perspective view of a bottom side of an embodiment of a positive bus bar terminal of a bus bar of the battery pack of FIG. 2.

FIG. 11 is a side view, at an enlarged scale, of a portion of the contact surface of the negative bus bar terminal of FIG. 9 or the positive bus bar terminal of FIG. 10.

FIG. 12 is another perspective view of a module of the battery pack of FIG. 2.

FIG. 13 is an exploded perspective view of the module of FIG. 12.

FIG. 14 is an exploded perspective view of an upper portion of the module of FIG. 12.

FIG. 15 is an exploded perspective view of the cells and a lower portion of the module of FIG. 12.

FIG. 16A is a perspective view of the module of FIG. 12, with the cover assembly thereof removed to show interior components of the module.

FIG. 16B is a top view of the module of FIG. 12, with the cover assembly thereof removed to show interior components of the module.

FIG. 17 is a perspective sectional view of the module of FIG. 12 showing the cell-holding structure thereof.

FIG. 18 is another perspective sectional view of the module of FIG. 12 showing the cell-holding structure thereof.

FIG. 19 is a perspective view of one of the cells of the battery pack of FIG. 2.

FIG. 20 is a perspective view of bus bars of the battery pack of FIG. 2 in contact with some subsets of cells of the battery pack of FIG. 2.

FIG. 21 is a perspective view of some bus bars and cells of the battery pack of FIG. 2.

FIG. 22 is a perspective view of a first embodiment of a cell biasing member of the battery pack of FIG. 2.

FIG. 23 is a perspective view of a second embodiment of a cell biasing member of the battery pack of FIG. 2.

FIG. 24 is a perspective view of a third embodiment of a cell biasing member of the battery pack of FIG. 2.

FIG. 25 is a perspective view illustrating a plurality of voltage taps for the battery pack of FIG. 2.

FIG. 26 is a schematic layout of a thermal management system in a multi-pack system that includes a plurality of battery packs in accordance with an embodiment of the present disclosure.

FIG. 27 is a schematic layout of a control system for the thermal management system shown in FIG. 26.

FIG. 28 is a schematic layout of the thermal management system when operating in a heating mode.

FIG. 29 is a schematic layout of the thermal management system when operating in a passive cooling mode.

FIG. 30 is a schematic layout of the thermal management system when operating in an active cooling mode.

FIG. 31 is a schematic layout of the thermal management system when operating in secondary cooling medium charging mode.

FIG. 32 is a schematic layout of the thermal management system when operating in an extinguishing mode.

FIG. 33 is a schematic layout of the thermal management system when operating in a passive cooling mode.

FIG. 34 is a schematic layout of an alternative layout for the thermal management system.

FIG. 35 is a schematic layout of another alternative layout for the thermal management system.

### DETAILED DESCRIPTION OF THE DISCLOSURE

### Interpretation

For simplicity and clarity of illustration, where considered appropriate, reference numerals may be repeated among the Figures to indicate corresponding or analogous elements. In addition, numerous specific details are set forth in order to provide a thorough understanding of the embodiment or embodiments described herein. However, it will be understood by those of ordinary skill in the art that the embodiments described herein may be practiced without these specific details. In other instances, well-known methods, procedures and components have not been described in detail so as not to obscure the embodiments described herein. It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

The indefinite article “a” is not intended to be limited to mean “one” of an element. It is intended to mean “one or more” of an element, where applicable, (i.e. unless in the context it would be obvious that only one of the element would be suitable).

Any reference to upper, lower, top, bottom or the like are intended to refer to an orientation of a particular element during use of the claimed subject matter and not necessarily to its orientation during shipping or manufacture. The upper surface of an element, for example, can still be considered its upper surface even when the element is lying on its side.

### Battery Pack in General

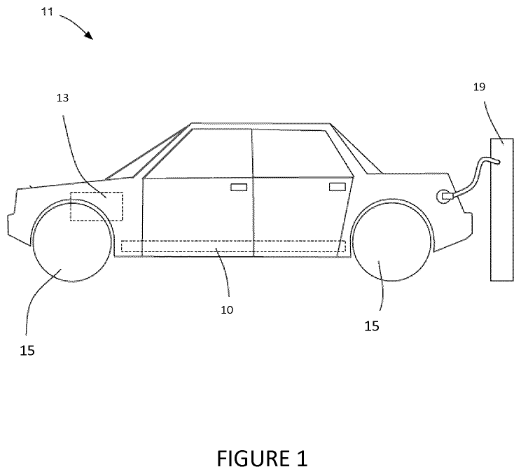

Reference is made to FIG. 1, which shows a battery pack 10 for an electric vehicle 11. The term ‘electric vehicle’ is intended to include any vehicle that includes an electric motor 13 that drives one or more wheels 15 of the vehicle 11. The vehicle 11 may include any other suitable type of energy storage device, in addition to the battery pack 10. The electric motor 13 may operate alone or may be one of a plurality of electric motors. Furthermore, the vehicle 11 may include other types of power devices such as an internal combustion engine.

The vehicle 11 shown in FIG. 1 is an automobile, however it will be understood that the vehicle 11 may be any other suitable type of vehicle, such as a minivan, a pickup truck, a commercial van or truck, a bus, an SUV, an ATV, a tracked or wheeled construction vehicle such as an excavator, a backhoe loader, a bulldozer, or a bobcat. The vehicle could further be a boat, or an aircraft. The vehicle may be operated remotely or by a driver. The vehicle may be entirely or partially autonomous, or not autonomous. The vehicle may carry one or more people and/or cargo, or may not carry anything.

The vehicle 11 is shown plugged into a charging station 19 in FIG. 1.

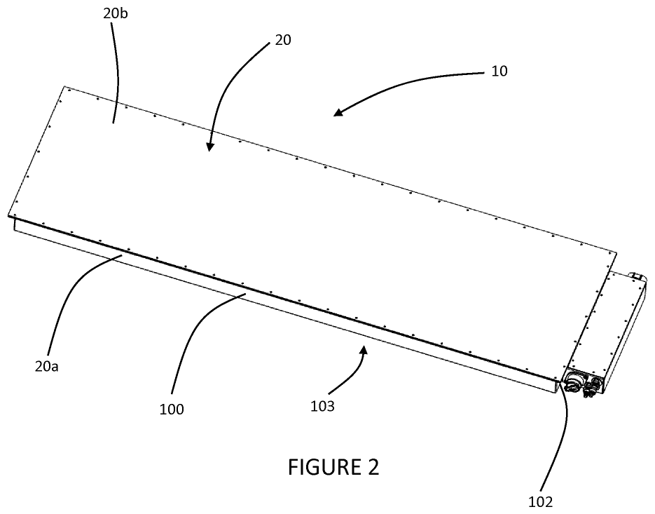

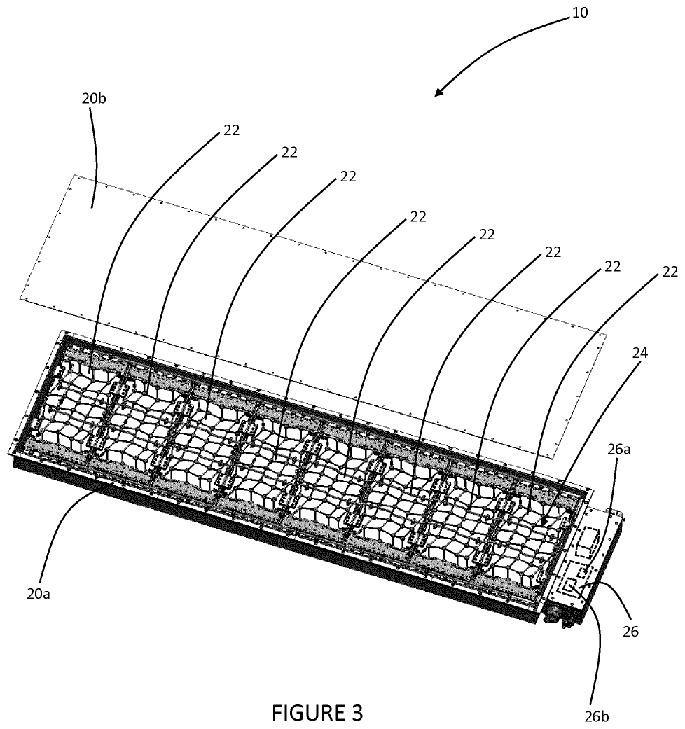

Reference is made to FIGS. 2 and 3, which shows the battery pack 10. The battery pack 10 includes a battery pack housing 20, a plurality of modules 22, a thermal management system 24 and a battery pack control system 26.

The battery pack housing 20 may include a bottom battery pack housing member 20a and a top battery pack housing member 20b, which is mounted to the bottom battery pack housing member 20a via a plurality of mechanical fasteners. The bottom battery pack housing member 20a may be in the form of a tub, having a bottom and a plurality of side walls, which can be filled with or hold a quantity of liquid if needed. The top battery pack housing member 20b may be a generally flat plate. The battery pack housing 20 may be formed from any suitable material such as a aluminum or a suitable polymeric material.

In the embodiment shown, the battery pack housing 20 has a substantially rectangular prismatic shape. The bottom battery pack housing member 20a has two elongate side walls 100 that extend in a horizontal longitudinal direction, and two end walls 102 that extend in a horizontal transverse direction perpendicular to the longitudinal direction, and a floor member 103. In other embodiments, the battery pack housing 20 may have other shapes. The modules 22 are arranged in the battery pack housing 20 in a row along the horizontal longitudinal direction. In the embodiment shown, the battery pack 10 has eight modules 22 that are disposed in the tub formed by the bottom battery pack housing member 20a. However, in other embodiments, the battery pack 10 may have any other suitable number of one or more module(s) 22.

### Module in General

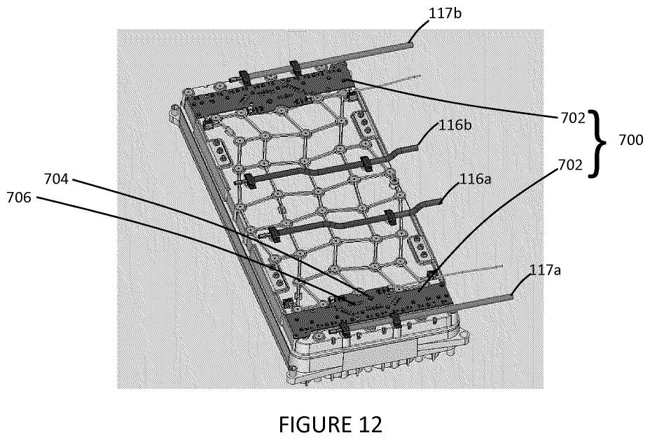

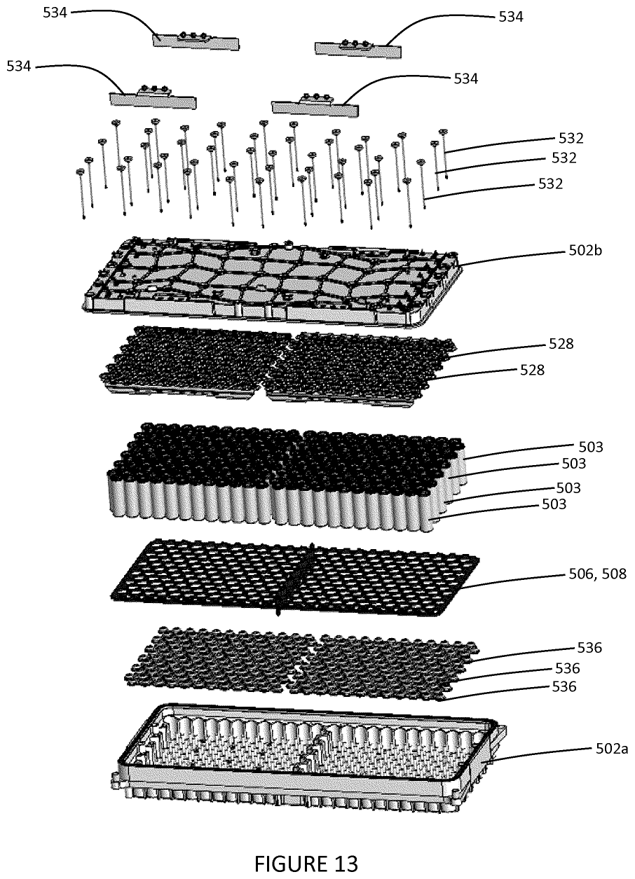

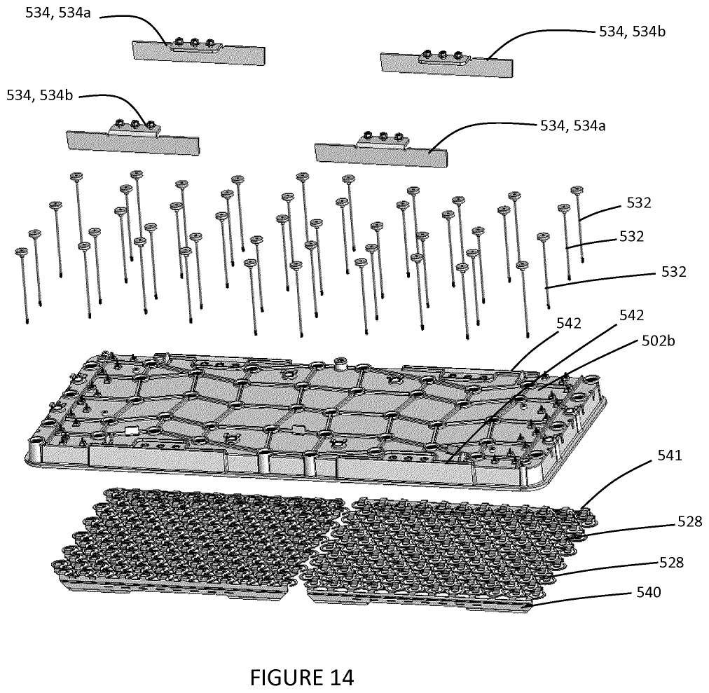

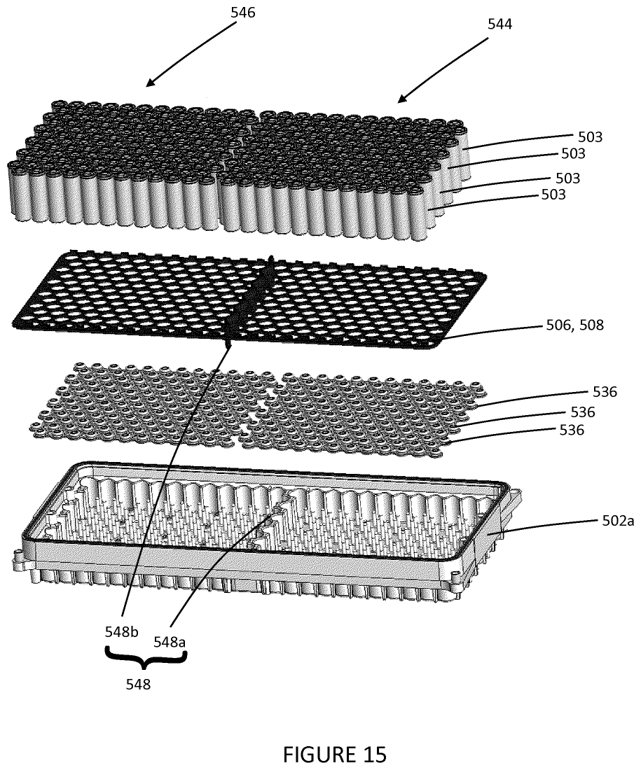

Reference is made to FIGS. 12-15, which show one of the modules 22. FIG. 12 is a perspective view of the module 22. FIG. 13 is an exploded view of components of the module 22. FIG. 14 is an exploded view of a cover assembly 500 of the module 22, and FIG. 15 is an exploded view of a lower portion 501 of the module 22 Each module 22 includes a module housing 502 and a plurality of cells 503. The module 22 may further include a plurality of bus bars 528, a plurality of voltage taps 530, a plurality of tension rods 532, and a plurality of module terminals 534, which may all form part of the cover assembly 500. The module 22 may further include a plurality of cell biasing members 536. The module may further include a module control system 700, which includes at least one controller 702.

### Module Housing

The module housing 502 may include a first module housing member 502a and a second module housing member 502b. In the embodiment shown, the first module housing member 502a forms an upper lid, while the second module housing member 502b forms a lower tub. The first and second module housing members 502a and 502b are sealingly connectable to one another in order at a joint 504 (FIG. 12) therebetween, to prevent leakage of the cooling fluid therebetween. The module housing 502 defines a cell chamber 505 in which the cells 503 are positioned. The cell chamber 505, in use, contains the cooling fluid in which the cells 503 are immersed in order to control the temperature of the cells 503.

The cooling fluid may be any suitable dielectric fluid that can be flowed through the cell chamber 505 to carry out heat transfer with the cells 503 (i.e. to and from the cells 503) and which prevents current from being transferred through the cooling fluid from cell 503 to cell 503. The cooling fluid is preferably a liquid so as to have a relatively high heat capacity, but in some embodiments, the cooling fluid may be a gas, such as a suitable refrigerant.

In the embodiment shown, a seal member 505 is present at the joint 504 between the first and second module housing members 502a and 502b, to assist in preventing leakage of the cooling fluid therebetween.

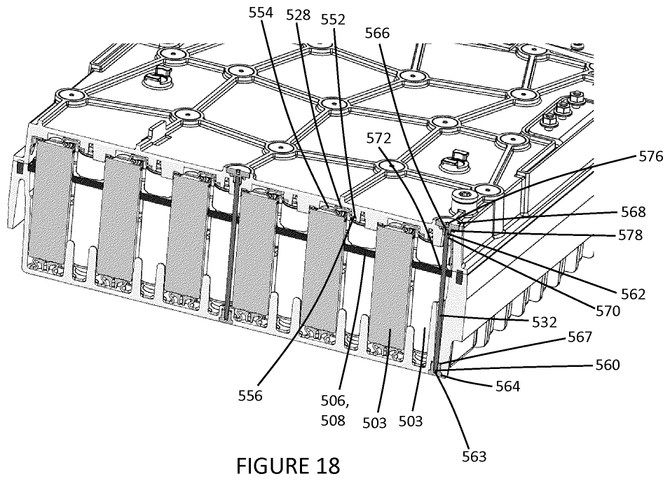

With reference to FIG. 18, the module housing 502 includes a cell-holding structure shown at 506, which may be any suitable structure for holding the cells 503 in place and to keep the cells 503 physically separated from one another.

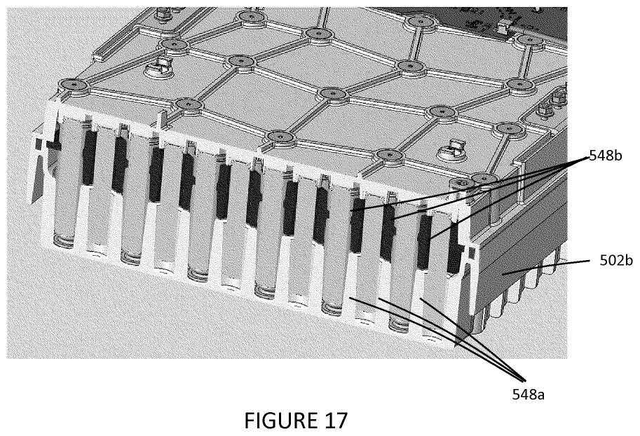

The cell-holding structure 506 may include a cell-holder plate 508 that is clamped between the first and second module housing members 502a and 502b at selected positions about the periphery of the cell-holder plate 508 (as shown at positions 510 in FIG. 17). The cell-holder plate 508 has a plurality of cell-holding apertures 512 that are each sized to snugly hold one of the cells 503. Each cell-holding aperture 512 includes a plurality of cooling fluid pass-through apertures 514 so as to permit the flow of cooling fluid across the cell-holder plate 508 during operation of the battery pack 10.

The cell-holding structure 506 further includes a plurality of interstitial projections 516 that extend upwards from a floor 518 of the housing 502 to surround each of the cells 503. The cell-holding apertures 512 in the cell-holder plate 508 and the interstitial projections 516 cooperate to hold each cell 503 in a selected position and to keep the plurality of cells 503 physically separated from one another so as to prevent a short circuit between the cells 503. It will be understood that any other suitable cell-holding structure 506 may alternatively be used to hold the cells 503 in place and physically separated from one another.

In the embodiment shown, the module housing 502 has a substantially rectangular prismatic shape. The module housing 502 has two side walls 104 that extend in the horizontal longitudinal direction parallel to the side walls 100 of the bottom battery pack housing member 20a, and two end walls 106 that extend in the horizontal transverse direction parallel to the end walls 102 of the battery of the bottom battery pack housing member 20a. The module housing 502 extends in the transverse direction across the battery pack housing 20 from one of its side walls 100 to another one of its side walls 100.

### Cells

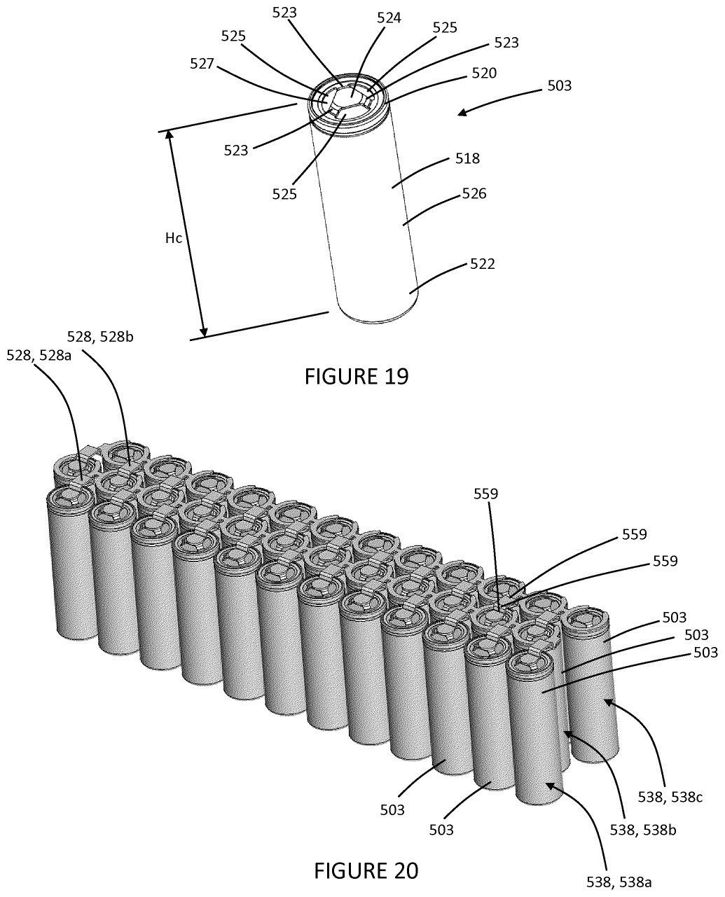

With reference to FIG. 19, each cell 503 includes a cell body 518, which has a first end 520 and a second end 522. In the embodiment shown, the first end 520 is the cell top, and the second end 522 is the cell bottom, however it will be understood that the cells 503 may be oriented differently in other embodiments, such as being oriented horizontally, for example. The cell 503 further includes a positive cell terminal 524 which is present at the first end 520, and a negative cell terminal 526. The negative terminal 526 envelops the entirety of the cell 503 except for a central portion of the first end 520, where the positive cell terminal 524 is positioned. As can be seen, the negative cell terminal 526 includes a peripheral portion of the first end 520.

Since both the positive and negative cell terminals 524 and 526 are positioned at the first end 520 of the cells 503, all of the cells 503 may be positioned in the module housing 502 oriented the same way (e.g. with the first end facing upwards (i.e. being the cell top, as noted above)). This reduces the potential for errors to be made during insertion of the cells 503 in the module housing 502 during assembly of the module 22, or during replacement of one or more cells 503 in the module 22.

In the embodiment shown, the positive cell terminals 524 of the cells 503 are supported by a plurality of struts 523 which are spaced apart by gaps 525. Beneath the positive cell terminal 524 is a burst disc 527, which permits the cell 503 to vent through the gaps 525 without exploding in the event that internal pressure within the cell body 518 exceeds a selected pressure.

The cells 503 may be any suitable type of electrochemical cell, such as those supplied by LG Chem, or by Panasonic. The cell body 518 may be cylindrical, as shown, or may have any other suitable shape. Each cell may have a voltage of about 4V when fully charged.

Each cell 503 has a cell height Hc between the first end 520 and the second end 522. There may be a tolerance in the manufacture of the cells 503, such that the cell height Hc may vary from cell 503 to cell 503.

### Description of Bus Bars, and Separate Pluralities of Cells In Module

The module 22 may further include a plurality of bus bars 528, a plurality of voltage taps 530, a plurality of tension rods 532, and a plurality of module terminals 534, which may all form part of the cover assembly 500. The module 22 may further include a plurality of cell biasing members 536.

The bus bars 528 connect subsets of the cells 503 to other subsets of the cells 503. Each subset is shown at 538. A first one of the subsets 538 is shown at 538a may be referred to as the first subset 538a of the cells 503, a second one of the subsets 538 of the cells 503 may be referred to as the second subset 538b of the cells 503, a third one of the subsets 538 of the cells 503 may be referred to as the third subset 538c of the cells 503, and so on. Each subset 538 of the cells 503 is unique, in the sense that each subset 538 contains no cells 503 in common with any other one of the subsets 538.

A first one of the bus bars 528 is shown at 528a in FIG. 20, and may be referred to as the first bus bar 528a, a second one of the bus bars 528 may be referred to as the second bus bar 528b, and so on. The first bus bar 528a engages the positive cell terminals 524 of the first subset 538a of the cells 503 and the negative cell terminals 526 of the second subset 538b of the cells 503. Similarly, the second bus bars 528b engages the positive cell terminals 524 of the second subset 538b of the cells 503 and the negative cell terminals 526 of the third subset 538c of the cells 503. This pattern continues throughout the plurality of cells 503 of the module 22 until a final one of the bus bars 528 (referred to as a final bus bar, which in the present embodiment is an eleventh bus bar 528k) engages the positive cell terminals 524 of a penultimate one of the subsets (which in the present embodiment is an eleventh subset shown at 538k) of the cells 503 and the negative cell terminals 526 of a final one of the subsets (which in the present embodiment is a twelfth subset shown at 538b) of the cells 503.

It will be noted that the cells 503 that make up each subset 538 are connected to by the associated bus bars 528 in parallel, and that each subset 538 of cells 503 is connected to the subsequent subset 538 of cells 503 in series. In the present example, the plurality of cells 503 in the module 22 are connected in a 12s12p configuration. In other words, there are one hundred and forty-four cells 503 consisting of twelve subsets 538 of twelve cells 503. The twelve cells 503 of each subset 538 are connected in parallel with each other. The cells 503 of each one of the twelve subsets 538 of cells 503 is connected in series with the cells 503 of a subsequent one of the subsets 538 of cells 503. However, any other suitable number of cells 503 may make up the plurality of cells 503, and they may be connected to in any suitable configuration, as is known in the art of battery modules.

Each subset 538 is shown in the present embodiment as being a single row of cells 503. However, it will be understood that each subset 538 may be any other arrangement of cells, such as, for example, a zigzag arrangement of cells 503, or a grouping of cells 503 that includes cells 503 from a plurality of rows of cells 503.

The module 22 further includes a first bus bar end member 540 that connects the negative terminals 526 of the first subset 538a of the cells 503, to a first one of the module terminals shown at 534a. The module 22 further includes a second bus bar end member 541 that connects the positive terminals 526 of the final subset 5381 of the cells 503, to a second one of the module terminals shown at 534b. The first one 534a of the module terminals 534 extends through a module terminal aperture 542 in the module housing 502 (in the present embodiment, through the second module housing member 502b), for connection to the second one 534b of the module terminals 534 of a prior one of the modules 22. The second one 534b of the module terminals 534 extends through another module terminal aperture 542 in the module housing 502 (in the present embodiment, through the second module housing member 502b), for connection to the second one 534a of the module terminals 534 of a subsequent one of the modules 22.

The first bus bar end member 540 may connect to the first module terminal 534a in any suitable way such as by a mechanical connection or by welding, soldering, brazing or the like. Similarly, the second bus bar end member 541 may connect to the second module terminal 534b in any suitable way such as by a mechanical connection or by welding, soldering, brazing or the like.

The plurality of cells 503 may be, as a group identified at 544. The plurality 544 of cells 503 may be a first plurality of cells. The module 22 may further include a second plurality of cells 503, identified at 546. In the embodiment shown, each module 20 has two hundred and eighty-eight cells 503, with each of the plurality 544 and the second plurality 546 of cells 503 consisting of one hundred and forty-four cells 503. Within each of the first plurality 544 and second plurality 546 of cells 503, the cells 503 are connected in the “12s12p” configuration as previously described. The second plurality 546 of cells 503, which has associated therewith another plurality of bus bars 528, another first bus bar end member 540 that connects the negative terminals 526 of the first subset 538a of the cells 503 of the second plurality 546 of cells 503, to another first module terminal 534a, and another second bus bar end member 541 that connects the positive terminals 526 of the final subset 5381 of the cells 503 of the second plurality 546 of cells 503, to another second module terminal 534b. As can be seen, in respect to the module 22 in isolation (as opposed to the battery pack 10 as a whole), the first plurality 544 of cells 503 are all electrically connected to one another, and the second plurality 546 of cells 503 are all electrically connected to one another, and are electrically isolated from the first plurality 544 of cells 503.

The first and second pluralities 544 and 546 of cells 503 may be separated by a divider wall shown at 548 to reduce the likelihood of an inadvertent electrical connection from being formed between any cells 503 from the first plurality 544 with any cells 503 from the second plurality 546, since the voltage that could be present during such inadvertent connection could be very high (hundreds of volts). The divider wall 548 may include a first portion 548a that is directly formed as part of the first module housing member 502a, and a second portion 548b that is directly formed as part of the cell-holder plate 508.

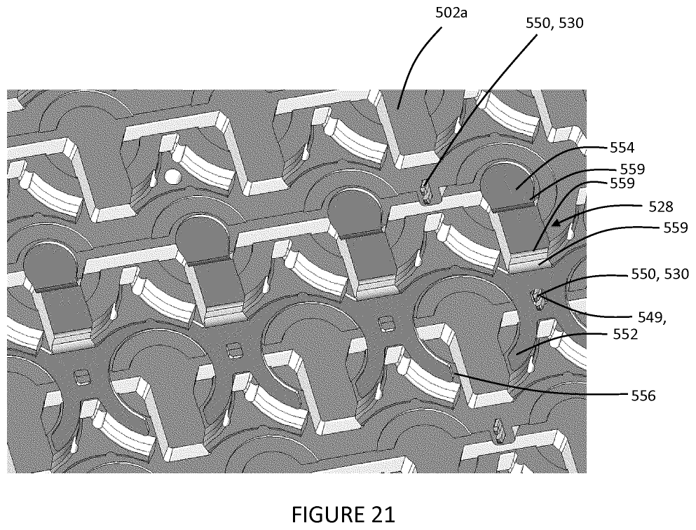

The bus bars 528 are described in further detail in relation to FIG. 21. Each bus bar 528 is mounted into the second module housing member 502b by any suitable means. For example, each bus bar 528 optionally includes at least one clip aperture 549, which receives a clip 550 that is molded into the second module housing member 502b. The bus bar 528 includes a plurality of negative bus bar terminals 552 which are positioned to engage the negative cell terminals 526 of the cells 503, and a plurality of positive bus bar terminals 554 which are positioned to engage the positive cell terminals 524 of the cells 503.

As can be seen in FIG. 18, the negative bus bar terminals 552 are in direct abutment with a support surface 556 of the second module housing member 502b. Thus, there is essentially no resiliency between the negative bus bar terminals 552 in the engagement. The positive bus bar terminals 554 are held by positive cell terminal supports 558 that extend between the positive bus bar terminals 554 and the negative bus bar terminals 552. The positive bus bar terminal supports 558 each have a plurality of bends 559 therein and are resiliently flexible. Additionally, the positive bus bar terminal supports 558 are spaced from the second module housing member 502b, so as to provide them with freedom of movement. Thus the positive bus bar terminal supports 558 are positive bus bar terminal biasing members that urge the positive bus bar terminals 554 into engagement with the positive cell terminals 524 of the cells 503.

In embodiments in which the positive cell terminals 524 of the cells 503 are supported by the plurality of struts 523, it is advantageous for the positive bus bar terminal 554 to be held by the resiliently flexible positive bus bar terminal support 558, so as to reduce the likelihood of applying so much force onto the positive cell terminal 524 that it collapses the struts 523.

It will be noted that, upon removal of the second module housing member 502b, all of the bus bars 528 are removed from the cells 503. Accordingly, in at least some embodiments, the cells 503 are electrically disconnected from one another, thereby reducing the likelihood of a service person or assembly line worker from getting injured when contacting the cells.

### Biasing Members With Low Force Variation

The plurality of cell biasing members 536 are described in further detail below. In the embodiment shown, with reference to FIG. 15, it can be seen that there is a biasing member 536 for each cell 503.

The plurality of cell biasing members 536 are positioned to urge each of the cells 503 and each of the positive and negative bus bar terminals 554 and 552 from the bus bars 528 into engagement with one another with at least a selected engagement force.

The cell biasing members 536 each have a biasing member height Hb, when they are urging the cells and the bus bar terminals 554 and 552 into engagement with one another. The biasing member heights Hb of the cell biasing members 536 extend over a range of values between a low height value and a high height value. The low and high height values depend in part on tolerances in the cell heights Hc of the cells.

The cell biasing members 536 may each have any suitable shape so as to provide a biasing force that varies by less than a selected amount, such as 30% of the biasing force provided at the high value for the cell biasing member height Hb, over the range of height values. In another aspect, a property of the cell biasing members 536 may be characterized as follows: the biasing force varies between a low biasing force at one of the low height value and the high height value, and a high biasing force at the other of the low height value and the high height value. The advantageous property of the cell biasing members 536 is that the ratio of the low biasing force to the high biasing force is less than the ratio of the low height value to the high height value.

The cell biasing members 536 are positioned at the second ends 522 of the cells 503, (i.e. the bottom ends), between the cells 503 and the first module housing member 502a.

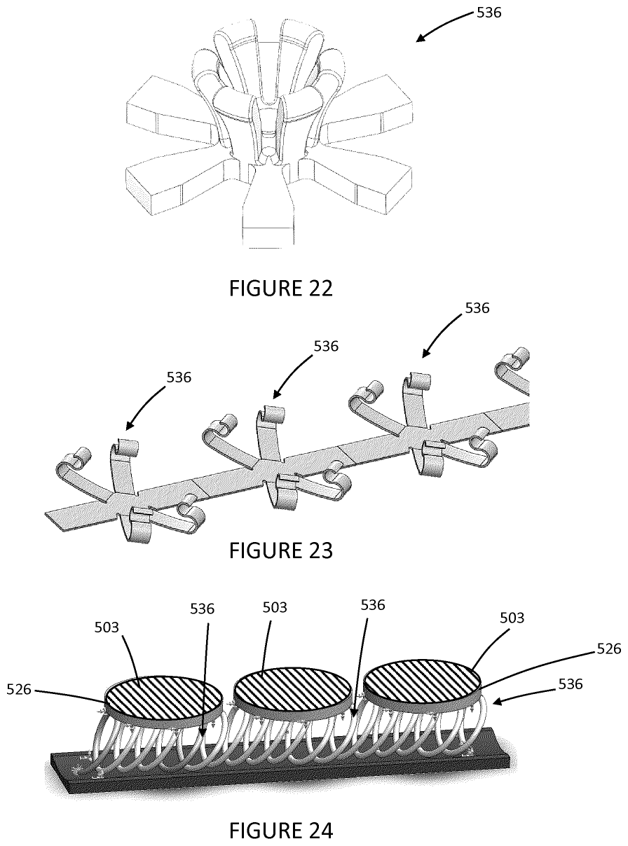

It will be understood that the shape of the cell biasing members 536 in FIG. 15 is but one example of a suitable shape. A different shape for the cell biasing members 536 may be used, such as any of the shapes which are shown in FIGS. 22, 23 and 24.

It can be seen that the cell biasing members 536 shown in FIGS. 18, 22 and 23 all operation on bending, as opposed to simple tension or compression.

The cell biasing members 536 may be connected to one another so as to be formed all together in a single molding process as one sheet, particularly in embodiments as shown in FIGS. 15 and 22, in which the cell biasing members 536 are made from a suitable polymeric material such as a suitable elastomer.

### Cell Biasing Members Electrical Connection in Parallel

In some embodiments, as shown in FIGS. 23 and 24, the cell biasing members 536 are made from an electrically conductive material such as a suitable steel. Additionally, the cell biasing members 536 may be connected together. This permits the cell biasing members 536 to act as a parallel connection to the negative cell terminals 526 of all the cells 503 in a particular subset 538. This provides an electrical flow path through all the cells 503 in a given subset 538 in the unlikely event that a particular negative bus bar terminal 552 is not properly engaged (or not engaged at all) with a particular cell 503.

### Tension Rods

The tension rods 532 are described in further detail with reference to FIG. 18. The tension rods 532 have a first end 560 and a second end 562. The first end 560 is connected at a first connection 563 to a first end member 564 that is positioned in engagement with the first module housing member 502a. The second end 562 of the tension rod 532 is connected at a second connection 566 to a second end member 568 that is positioned in engagement with the second module housing member 502b. The tension rods 532, in combination with the first and second end members 564 and 568 hold the second module housing member 502b in place to inhibit bowing of the second module housing member 502b as a result of pressure from the cooling fluid therein, and from forces of engagement between the cells 503 and the bus bars 528.

At least one of the first and second connections is a releasable threaded connection. The other of the first and second connections 563 and 566 may be a releasable threaded connection, may alternatively be some other type of releasable connection such as, for example, a bayonet connection, or may be a permanent connection.

The first end member 564 may be held in the first module housing member 502a in any suitable way, such as by means of a press-fit non-rotatably into an insert receiving aperture 566. A seal member 567 (e.g. an o-ring) may be positioned between the first end member 564 and the first module housing member 502a to prevent leakage of the cooling fluid from the cell chamber 505. As another option, the first end member 564 may be molded directly into the first module housing member 502a.

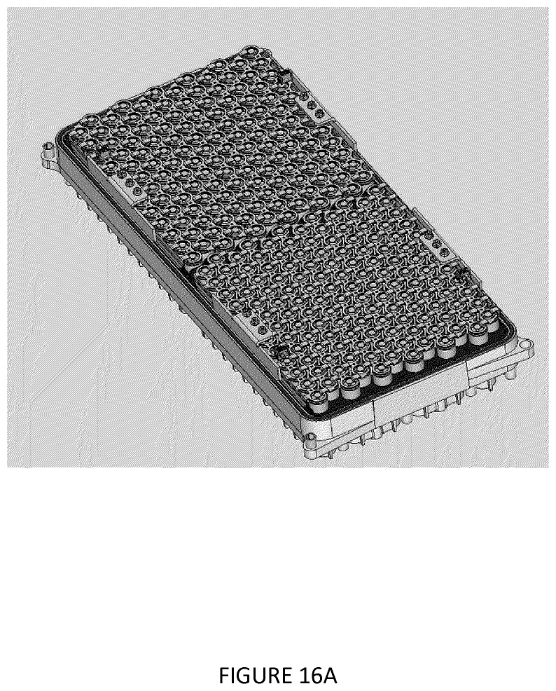

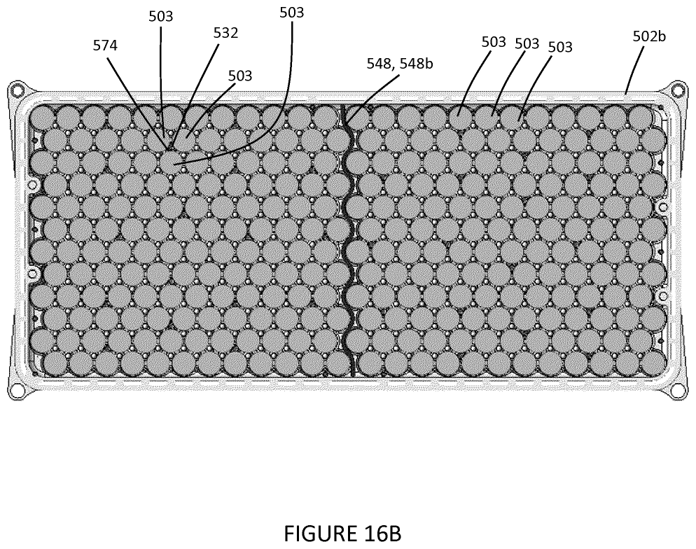

The second end member 568 is removable from engagement with the second module housing member 502b. In the embodiment shown, the second end member 568 is permanently connected to the second end 562 of the tension rod 532, and the first connection 563 between the first end 560 and the first end member 564 is a releasable threaded connection. To mount the tension rods 532 in place, each tension rod 532 with the second end member 568 thereon is inserted through a tension rod aperture 570 in the second module housing member 502b. The tension rod 532 is passed through a tension rod aperture 572 in the cell-holder plate 508, and along an interstitial space 574 (also seen in FIG. 16B) between the cells 503. The tension rod 532 is passed through a tension rod aperture 572 in the first module housing member 502a until the first end 560 enters the first end member 564. The second end member 568 includes a tool-receiving feature 576 such as a hexagonal aperture for receiving a tool (not shown), such as a hex-head bit. The tool may be turned to rotate the second end member 568 until the second end member pushes the second module housing member 502b down. As the tool is further rotated, all of the of positive and negative bus bar terminals 554 and 552 engage the corresponding positive and negative cell terminals 524 and 526 of the corresponding cells 503. The cell biasing members 536 apply a resistive biasing force on the cells 503. Eventually, as the tool is further turned the engagement of the positive and negative bus bar terminals 554 and 552 with the positive and negative cell terminals 524 and 526 is sufficiently strong that all of the cell biasing members 536 apply a resistive biasing force that exceeds a selected threshold. This, in turn results in an increase in the torque required to further rotate the second end member 568. A torque sensor may be provided, for sensing when the torque required to rotate the tool exceeds a selected torque threshold, at which point the tool may be stopped and removed from the second end member 568. Stoppage of the tool may occur automatically, by a controller, or manually upon notification to an assembly person.

In another embodiment, the tension rod 532 may be permanently mounted to the first end member 564 and thus may remain permanently in the first module housing member 502a. In such an embodiment, the second module housing member 502b is placed on top of the first module housing member 502a such that the tension rods 532 extend through the tension rod apertures 572 in the second module housing member 502b. At that point, the second end members 568 may be mounted to the second ends 562 of the tension rods 532 and may be tightened down (i.e. rotated) as described above until the torque required to tighten them down exceeds the aforementioned selected torque threshold.

A second end member seal member 578 may be provided between the second end member 568 and the second module housing member 502b in order to prevent leakage of cooling fluid out from the tension rod apertures 572.

Once a tension rod 532 is tightened down to the selected torque, it will be understood that the bus bars 528 in proximity to it are abutted with a selected force against the tallest cell 503 in proximity to it. Since the cell biasing members 536 are configured to apply a relatively constant force over a range of distance equal to the range of tolerances of the cells 503, all the cells 503 will be in contact with the bus bars 528 with approximately the same force. This provides a more consistent amount of contact resistance from cell 503 to cell 503 across the module 22, as compared to some modules of the prior art, without the need to resort to inserting tension rods into every single interstitial space 574 between all cells 503.

The tension rods 532 may have a relatively small cross-sectional area since they are in tension. For example, in some embodiments, the tension rods 532 may be cylindrical, and may have a diameter of about 3 mm or even 2 mm in some embodiments. By having a small diameter for the tension rods, it will be noted that the cells 503 can be nested in an offset pattern so as to have a high packing density. It is well known that cylindrical bodies pack less tightly when they are arranged in even rows and columns, and pack more tightly when packed in an offset pattern, (i.e. in the pattern shown in the present figures such as FIG. 16B). In some battery packs of the prior art, however, large members extend in the interstitial spaces between the cells and would not permit the cells to be arranged in an offset pattern. However, in the presently shown module, the cells 503 are arranged in an offset pattern, which reduces the size of the interstitial spaces 574 therebetween as compared to cells that are arranged into a linear arrangement of rows and columns. The tension rods 532 shown, however, fit easily in the smaller interstitial spaces 574 provided by the offset pattern, without risk of contacting the cells 503. Furthermore, the immersion cooling of the cells 503 provided by the presently described embodiments permits the cells 503 to be temperature controlled to a suitable degree in spite of their high packing density.

### Textured Contact Surface of Bus Bar

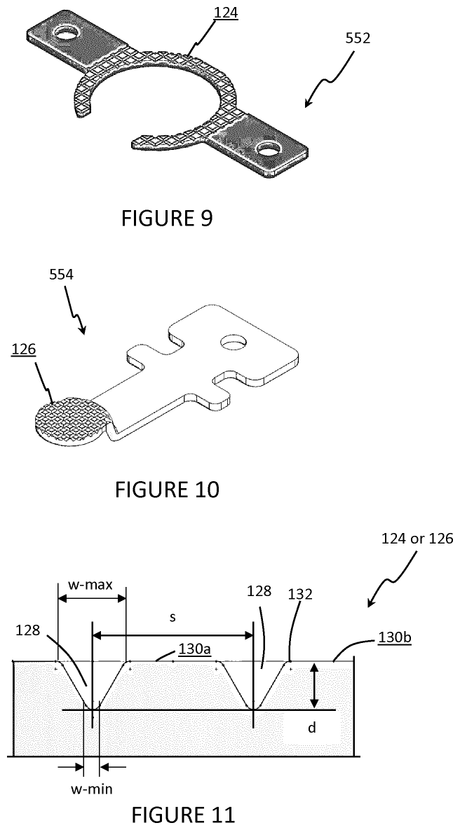

Reference is made to FIGS. 9 and 10, showing the bottom side of a negative bus bar terminal 552 and a positive bus bar terminal 554, respectively. The negative bus bar terminal 552 and the positive bus bar terminal 554 both define contact surfaces 124 and 126, respectively, for contacting the negative terminal and positive terminal, respectively, of a cell 503. For reference of scale, in the embodiment shown, the arcuate contact surface 124 of the negative bus bar terminal 552 has an outer diameter of about 21 millimeters and an inner diameter of about 16 millimeters. The substantially circular contact surface 126 of the positive bus bar terminal has a diameter of about 8 millimeters.

Reference is made to FIG. 11 showing a side view of the contact surface 124 or 126 of the negative bus bar terminal 552 or the positive bus bar terminal 554, respectively. The contact surface 124 or 126 defines a plurality of recesses 128 in the form of V-shaped grooves having a vertical depth, d, that may be any suitable value such as about 0.3 millimeters, a second (e.g. maximum) horizontal width, w-max, that may be any suitable value such as about 0.3 millimeters, a first (e.g. minimum) horizontal width, w-min, that may be any suitable value such as about 0.1 millimeters, and a horizontal spacing, s, that may be any suitable value such as of about 1.0 millimeter, as measured between cusps of the adjacent recesses 128. The depth, d, and minimum width, w-min, of the recess 128 are selected so that the recess 128 can receive small scale contaminant particles, such as human hair, dust, or aerosolized paint specks. For reference, the average human hair has a diameter of about 0.12 mm. When received in the recess 128, the contaminant particle will not prevent electrical contact between the contact surface portions 130a and 130b with the terminal of a cell 503. In the embodiment shown in FIGS. 9 and 10, the V-shaped groove recesses 128 run in mutually perpendicular directions so as to define square contact surface portions 130a and 130b of the contact surface 124 or 126. Accordingly, the contact surface 124 or 126 is textured to have a hobnail-like pattern. In the embodiment shown in FIG. 11, the edges 132 of the contact surface portions 130a and 130b may form sharp corners, as opposed to smooth or gradually rounded corners. The sharpness of the edges 128 may be selected so that they act like knife-edges to sever contaminant particles such as human hairs trapped between the contact surface 124 or 126 and a surface of the cell terminal, when the contaminant particle is subjected to adequate pressure between the contact surface 124 or 126 and a terminal of a cell 503.

In other words and more broadly stated, the contact surface 124 or 126 is textured so as to define contact surface portions 130a and 130b that are horizontally connected by vertical recesses 128. The recesses 128 may have a variety of forms, with non-limiting examples being elongate grooves or dimples, or a combination of them. The recesses 128 may be formed in a variety of ways, such as by molding, etching, pressing or machining. The recesses 128 have a vertical depth, d, measured from the contact surface portions 130a and 130b, of at least 0.2 millimeters, and more particularly at least 0.3 millimeters. As a non-limiting example, the depth, d, of the recess 128 may be in range of 0.2 millimeters to 0.5 millimeters and subranges thereof. The recesses 128 may have a width, w, of at least 0.2 millimeters, and more particularly at least 0.3 millimeters. As a non-limiting example, the minimum width, w-min, may be in the range of 0.2 millimeters to 0.5 millimeters and subranges thereof.

### Single Module Across Width of Battery Pack & Connection of Modules in Battery Pack

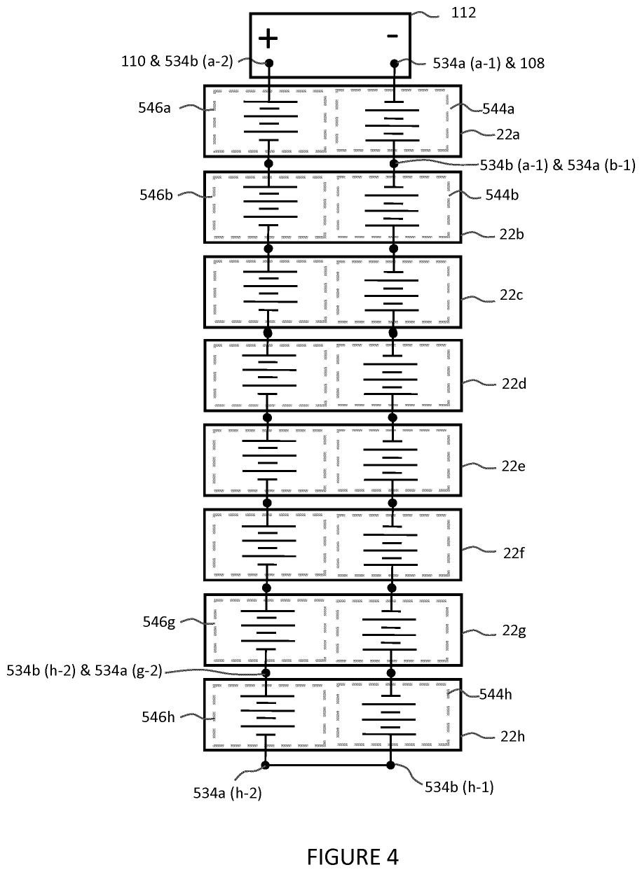

Reference is made to FIG. 4 which shows a schematic depiction of the electrical connection of the modules 22 of the battery pack 10. The battery pack 10 has a negative battery pack terminal 108 and a positive battery pack terminal 110 for connection to an electric circuit (not shown) of the electric vehicle 11 (FIG. 1). It is desirable for the negative battery pack terminal 108 and the positive battery pack terminal 110 to be positioned at a single end of the battery pack housing 20 for convenient connection to a part of the electric circuit such a battery disconnect unit (BDU) 112 of the electric vehicle 11.

As previously described, in the embodiment shown, the battery pack 10 has eight modules 22 denoted 22a through 22h. Each module 22 has a module housing 502 containing first and second pluralities 544, 546 of cells 503, each of which is connected to a corresponding first module terminal 534a and a second module terminal 534b. When each module 22 is considered in isolation, the first and second pluralities 544 and 546 of cells 503 are not electrically connected. However, in the battery pack 10 as a whole, they are electrically connected indirectly (for modules 22a to 22g) or directly (for module 22h) to each other so that electric current can flow through them using the common negative battery pack terminal 108 and positive battery pack terminal 110.

The first module end terminal 534a (a-1) of the first plurality 544a of cells 503 of a first module 22a is connected to or forms the negative battery pack terminal 108. The second module end terminal 534b (a-2) of the second plurality 546a of cells 503 of the first module 22a is connected to or forms the positive battery pack terminal 110.

The second module end terminal 534b (a-1) of the first plurality 544a of cells 503 of the first module 22a is connected to the first module end terminal 534a (b-1) of the first plurality of 544b of cells 503 of the second module 22b. The first plurality 544 of cells 503 of each subsequent module 22 is connected in a like manner to a successive module 22, up to and including the eight module 22h.

The second module end terminal 534b (h-1) of the first plurality 544h of cells 503 of the eighth module 22h is connected to the first module end terminal 534a (h-2) of the second plurality of 544b of cells 503 of the eighth module 22b.

The second module end terminal 534b (h-1) of the second plurality 546h of cells 503 of the eighth module 22h is connected to the first module end terminal 534a (g-2) of the second plurality 546g of cells of the seventh module 22g. The second plurality 546 of cells 503 of each preceding module 22 is connected in a like manner to a preceding module, up to and including the first module 22a.

In other words and more broadly stated, the battery pack 10 has a battery pack housing 20 that contains a plurality of modules 22 arranged in a row in the longitudinal direction of the battery pack 10. Each module 22a has a module housing 502 that extends in the traverse direction of the battery pack 10 between side walls 100 of the battery pack housing 22. Each module housing 502 contains first and second pluralities 544 and 546 of cells 503, arranged side-by-side in the traverse direction of the battery pack 10.

For each module 22 considered in isolation, the cells 503 of the first plurality 544 of cells 503 are electrically connected to one another; and the cells 503 of the second plurality 546 of cells 503 are electrically connected to one another. However, the second plurality 546 of cells 503 is electrically isolated from the first plurality 544 of cells 503, when the cell is considered in isolation (i.e., before forming part of the battery pack 10). For each module 22, the first plurality 544 of cells 503 is connected to a first module end terminal 534a (1) and a second module end terminal 534b (1). For each module 22, the second plurality 546 of cells 503 is connected to a first module end terminal 534a (2) and a second module end terminal 534b (2).

In the battery pack 10, the modules 22 are electrically connected together. The first module end terminal 534a (1) of the first plurality 544 of cells 503 of the first module 22 in the row is connected to or forms a battery pack terminal 108. The second end terminal module 534b (2) of the second plurality 546 of cells 503 of the first module 22 in the row is connected to or forms another battery pack terminal 110.

The first pluralities 544 of cells 503 of the modules 22 are connected in series, via module first and second end terminals 534a (1) and 534b (1) between successive modules 22 in the row, to form a series-connected set of first pluralities 544 of cells 503. The second pluralities 546 of cells 503 of the modules 22 are connected in series, via module end terminals 534a (2) and 534b (2) between successive modules 22 in the row, to form a series-connected set of second pluralities 546 of cells 503. The set of first pluralities 544 of cells 503 is connected in series to the set of second pluralities 546 of cells 503, by virtue of the first plurality 544 of cells 503 in the last module 22 of the row being connected in series with the second plurality 546 of cells 503 of the same last module 22 of the row, via the second module end terminal 534b (1) of the first plurality 544 of cells and the first module end terminal 534a (2) of the second plurality 546 of cells 503. Accordingly, except for the last module 22 of the row, the first and second plurality 544 and 546 of cells 503 within each module 20 are not directly connected to each other.

The battery pack terminals 108 and 110 are positioned at one end of the battery pack 10. Accordingly, the electrical circuit path of the first and second pluralities 544 and 546 of the modules 22, collectively, has a U-shaped configuration in a plane containing the row of modules 22. Structurally, however, the first and second pluralities 544 and 546 of each module 22 are contained in a single housing 502. This improves upon a conventional configuration of two physically discrete side-by-side rows of modules, which results in a structural weakness between the rows of modules. In embodiments in which the modules housings 502 are contained in a common battery pack housing 20 and engaged therewith (e.g., by connection to the battery pack housing 20 and/or by compression between the bottom battery pack housing member 20a and the top battery pack housing member 20b) the module housings 502 may also effectively reinforce the battery pack housing 20, and strengthen and rigidify the battery pack 10.

### Voltage Taps Through Housing

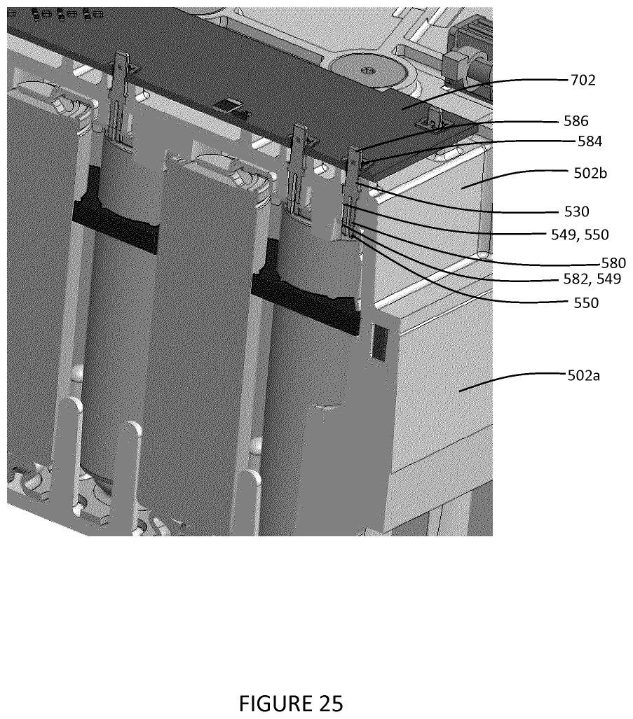

Reference is made to FIGS. 12 and 25. In the present embodiment, as shown in FIG. 12, the module control system 700 includes two module controllers 702, each of which is dedicated to one of the pluralities 544 and 546 of cells 503, and each of which communicates with the battery pack control system 26. The module controllers 702 each include a processor 704 and a memory 706 that stores program code for execution by the processor 704. The program code may be for communicating temperature data relating to the module 22 to the battery pack control system 26. For example, the data may be sensor data from one or more temperature sensors (not shown) that sense the temperature of the cooling fluid entering and/or leaving and/or in a selected position in the module 22. The data may be sensor data from the plurality of voltage taps 530.

The plurality of voltage taps 530 (FIG. 25) are conductive members that extend through the module housing 502, and which each have a first end 580 that is in a press-fit engagement with a bus-bar voltage tap receiving aperture shown at 582 in the bus bar 528 (FIG. 21), and which have a second end 584, which is received in a press-fit engagement with a controller voltage tap receiving aperture shown at 586.

In the embodiment shown, the clip member 550 that is present to hold the bus bar 528 is at the first end 580 of the voltage tap 530, and the bus-bar voltage tap receiving aperture 582 is the clip aperture 549 in the bus bar 528. Thus the voltage taps 530 help to retain the bus bars 528 in place on the second module housing member 502b.

The voltage taps 530 may be molded directly into the second module housing member 502b. As a result a separate seal member is not required to be included with each voltage tap 530. There may be a voltage tap provided for each bus bar present in the module 22.

### Modules Connected in Parallel by Topside Accessible Cooling Fluid Supply and Return Hoses

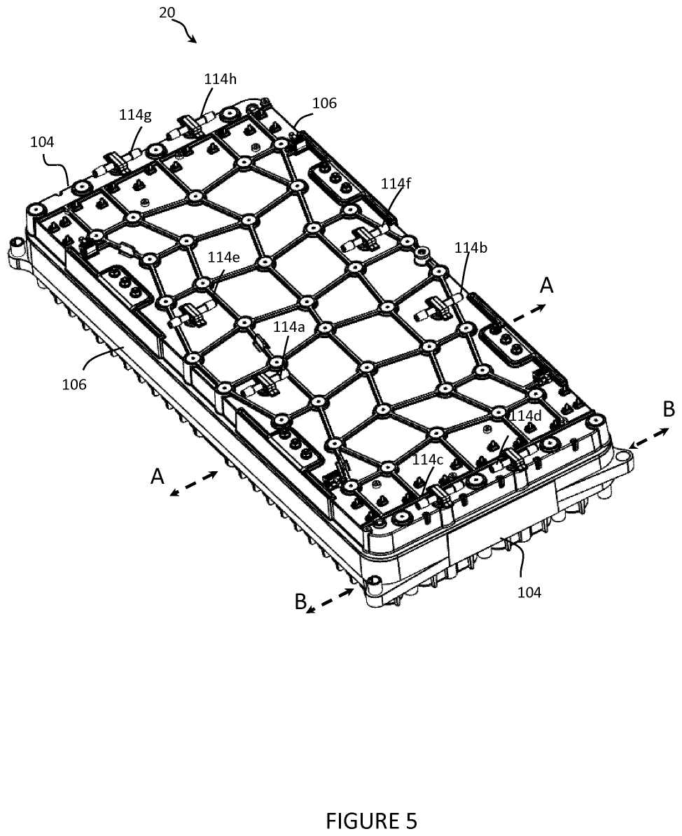

Reference is made to FIGS. 5 to 7 showing views of a module 22 of the battery pack 10. In the embodiment shown, the first module housing member 502a has an upper surface to which eight tubular T-shaped barbed hose fittings 114a to 114h (generally 114) are attached. The four hose fittings 114a to 114d are associated with the first plurality 544 of cells 503 of the module 22; and the four hose fittings 114e to 114g are associated with the second plurality 546 of cells 503 of the module 22. Referring to FIG. 12, hose fittings 114a, 114b are connected to first cooling fluid supply hoses 116a; hose fittings 114c and 114d are connected to first cooling fluid return hoses 117a; hose fittings 114e and 114f are connected to second cooling fluid supply hoses 116b; and hose fittings 114g and 114h are connected to second cooling fluid return hoses 117b. In general, each cooling fluid supply hose may be designated by reference numeral 116, and each cooling fluid return hose may be designated by reference numeral 117.

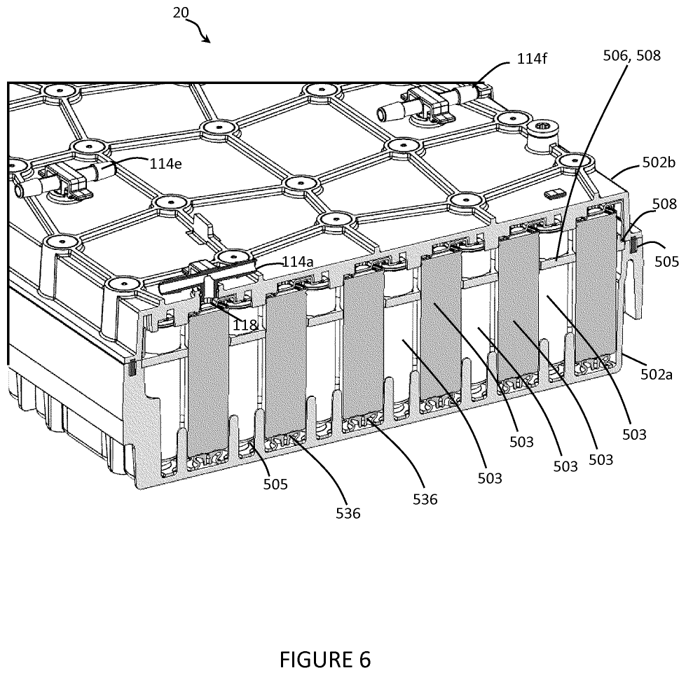

Reference is made to FIG. 6 showing a sectional view of FIG. 5 along section line A-A, intersecting the hose fitting 114a. The central branch of the hose fitting 114a is sealingly received with a module housing cooling fluid inlet 118 defined by an upper surface of the first module housing member 502a, such that the lumen of the hose fitting 114a is in fluid communication with the cell chamber 505. Although not shown, the central branches of hose fittings 114b, 114e and 114f are similarly received within three other module housing cooling fluid inlets 118 defined by the upper surface of the first module housing member 502a. Accordingly, cooling fluid can flow from the first cooling fluid supply hoses 116a and 116b (FIG. 12), via hose fittings 114a and 114b, into the cell chamber 505, whereupon the cooling fluid passes through the cooling fluid pass-through apertures 514 (FIG. 18) of the cell-holder plate 508 to immerse the first plurality 544 of cells 503 of the module 22. Similarly, cooling fluid can flow from the second cooling fluid supply hose 116b (FIG. 12), via hose fittings 114e and 114f, into the cell chamber 505, to immerse the second plurality 546 of cells 503 of the module 22.

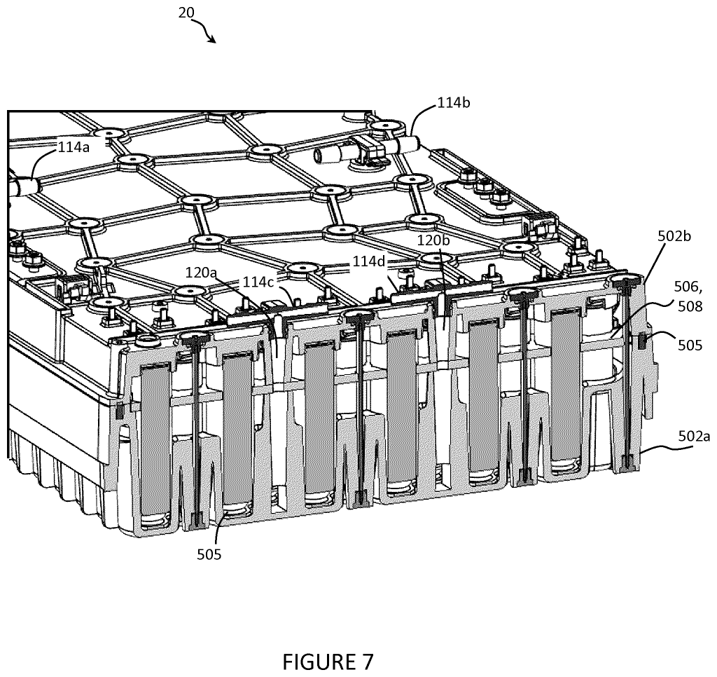

Reference is made to FIG. 7 showing a sectional view of FIG. 5 along section line B-B, intersecting the hose fittings 114c and 114d. The central branch of each of the hose fittings 114c and 114 is sealingly received with a module housing cooling fluid outlet 120a and 120b, respectively (generally 120), defined by an upper surface of the first module housing member 502a and extending downwardly toward the second module housing member 502b, such that the lumen of each of the hose fittings 114c and 114d is in fluid communication with the cell chamber 505. Although not shown, the central branches of hose fittings 114g and 114h are similarly received within two other module housing cooling fluid inlets 120 defined by the upper surface of the first module housing member 502a. Accordingly, cooling fluid can flow upwardly from the cell chamber 505, via the module housing cooling fluid outlets 120a and 120b and into the hose fittings 114c and 114d, respectively, and into the first cooling fluid return hose 117a. Similarly, cooling fluid can flow upwardly from the cell chamber 505, via two other module housing cooling fluid outlets 120 and into the hose fittings 114g and 114h, respectively, and into the second cooling fluid return hose 117b.

In the embodiment shown in FIG. 5, the module housing 502 defines two module housing cooling fluid inlets 116 and two module housing cooling fluid inlets 117 for each of the first and second pluralities 544 and 546 of cells 503 of the module 22. In other embodiments, the module housing member 502 may define any other suitable number (i.e., one or more) module housing cooling fluid inlets 116 and module housing cooling fluid inlets, which can be selected having regard to factors such as the shape and dimension of the cell chamber 505, the flow rate of cooling fluid to be supplied to the cell chamber 505, the expected heat output of the cells 503, and the desired cooling performance.

In the embodiment shown in FIG. 5, the module housing 502 defines the module housing cooling fluid inlets 118 in relative

proximity to the divider wall 548 (FIG. 15) separating the first and second pluralities 544 and 546 of cells 503 of the module 22, and relatively distal horizontally from the side walls 104 (FIG. 12) of the module housing 502. Conversely, the module housing 502 defines the module housing cooling fluid outlets 120 in relative horizontal proximity to the side walls 104 of the module housing 502, and relatively distal horizontally from the divider wall 548 (FIG. 15) of the module 22. This arrangement of module housing cooling fluid inlets 118 and module housing cooling fluid outlets 120 results in an overall cooling fluid flow downwardly through the cell chamber 505, and horizontally through the cell chamber 505 in the transverse direction toward the side walls 104 of the module housing 502. In other embodiments, the module housing cooling fluid inlet(s) 118 and module housing cooling fluid outlet(s) 120 may have a different arrangement to effect different patterns of cooling fluid flow through the cell chamber 505.

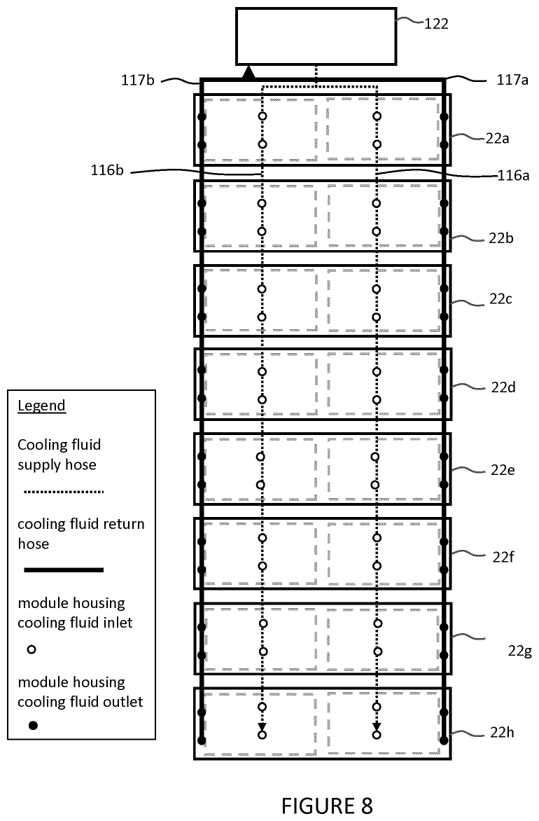

Reference is made to FIG. 8 showing a schematic depiction of the cooling fluid supply hoses 116 and cooling fluid return hoses 117 in relation to the eight modules 22a to 22h of the battery pack 10. In use, the cooling fluid supply hoses 116a and 116b, and the cooling fluid return hoses 117a and 117b are in fluid communication with a cooling fluid source 122. As a non-limiting example, the cooling fluid source 122 may be part of a cooling fluid circuit of a thermal management system (not shown) of the electric vehicle 11, which includes components such as a reservoir, pump(s), valve(s), and heat exchanger(s). Cooling fluid flows from the cooling fluid source 122, via the cooling fluid supply hoses 116a and 116b and module housing cooling fluid inlets 118, into the cell chambers 503 of the modules 22a to 22h. Accordingly, the cooling fluid source 122 supplies cooling fluid to the modules 22a to 22h in parallel with each other. The cooling fluid flows through the cell chambers 505 to absorb heat from the cells 503 therein. The heated cooling fluid then flows from the cell chambers 505 of the modules 22a to 22h, via the module housing cooling fluid outlets 120 and the cooling fluid return hoses 117a and 117b, back to the cooling fluid source 112. Accordingly, the modules 22a to 22h return the cooling fluid in parallel to the cooling fluid source 122.

In other words and more broadly stated, the battery pack 10 has a battery pack housing 20 containing a plurality of modules 22. Each module 22 has a module housing 502 defining a cell chamber 505 that contains a plurality of cells. The module housing 502 has an upper surface that defines at least one module housing cooling fluid inlet 118 in fluid communication with cell chamber 505, and at least one module housing cooling fluid outlet 120 in fluid communication with the cell chamber 505. By virtue of the module housing cooling fluid inlet(s) 118 and at least one module housing cooling fluid outlet(s) 120 being defined by the upper surface of the module housing 502 they are conveniently accessible via a topside of the module 22. A cooling fluid supply hose 116 is in fluid communication with the module housing cooling fluid inlet(s) 118 of two or more modules 22, to allow for supply flow of cooling fluid from a cooling fluid source 122 to the cell chambers 505 of the two or more modules 22, in parallel. A cooling fluid return hose 117 is in fluid communication with the module housing cooling fluid outlet(s) 120 of the two or more modules 22, to allow for return flow of cooling fluid from the cell chambers 505 of the two or more modules 22, in parallel, to the cooling fluid source 122.

### Charging, Use and Operation of Battery Pack

The charging time for the cells 503 may be decreased by increasing the power of the charging source by increasing its voltage and or current. As well, the power output of cells 503 can be increased by increasing their discharge rate. However, increased charging and discharge rates are associated with an increase in heat produced by the cells 503, which has deleterious effects on battery life, physical degradation and safety considerations. Thus, the charging and discharge rates are typically moderated as a compromise for preserving battery life. In electric vehicle applications, for example, the peak C-rate is typically limited to about 3.0 C and the average C-rate over the range of state-of-charge is typically limited to about 1.0 C to 2.0 C. (The C-rate is a metric of the rate at which a battery is charged or discharged relative to its maximum capacity. For example, a C-rate of 1 C means that the battery pack will fully charge or discharge in one hour, whereas a C-rate of 3 C means that the battery pack will fully charge or discharge in twenty minutes.) In addition, the depth of charge (DoC) and depth of discharge (DoD) of a battery pack is also typically limited to a range greater than 80 percent but less than 100 percent to preserve battery life. (DoC or DoD refer to the percentage of the battery pack capacity to which the battery pack is charged or discharged, respectively.)

The battery pack 10 as described may be an immersion cooled battery pack. That is, the cells 503 within the cell chamber 505 of the modules 22 may be in direct contact with a liquid cooling fluid in the cell chamber 503, so as to conductively transfer heat from the cells 503 to the cooling fluid. Immersion cooling may be advantageous in terms of heat transfer efficiency and thermal control of the cells 503 in comparison to air cooling or indirect liquid cooling (e.g., using heat exchangers carrying a heat exchanger medium).

The battery pack 10 as described may have cells 503 that are removable from the module housings 502. This is because the cell biasing members 536 may be configured to apply a sufficient biasing force to the cells 503 to maintain electrical contact between the positive cell terminals 524 and the positive bus bar terminals 554, and between the negative cell terminals 526 and the negative bus bar terminal 552 under expected operating conditions. This avoids the need for welding the positive and negative cell terminals 524 and 526 to the positive and negative bus bar terminals 554 and 552, respectively. As a result, the cells 503 can be conveniently replaced if their performance degrades to an unsatisfactory level or if they are damaged.

The combination of battery pack 10 having immersion cooled cells 503 and removability of the cells 503 enables the battery pack 10 to be charged and discharged at higher C-rates, and used with higher DoC and higher DoD. This is because immersion cooling allows for more effective thermal control of the cells 503, and removability of the cells 503 allows for more convenient sacrificial replacement of underperforming or damaged cells 503 with new cells 503 during the life cycle of the battery pack 10.

### Optional Layout of Multi-Pack System

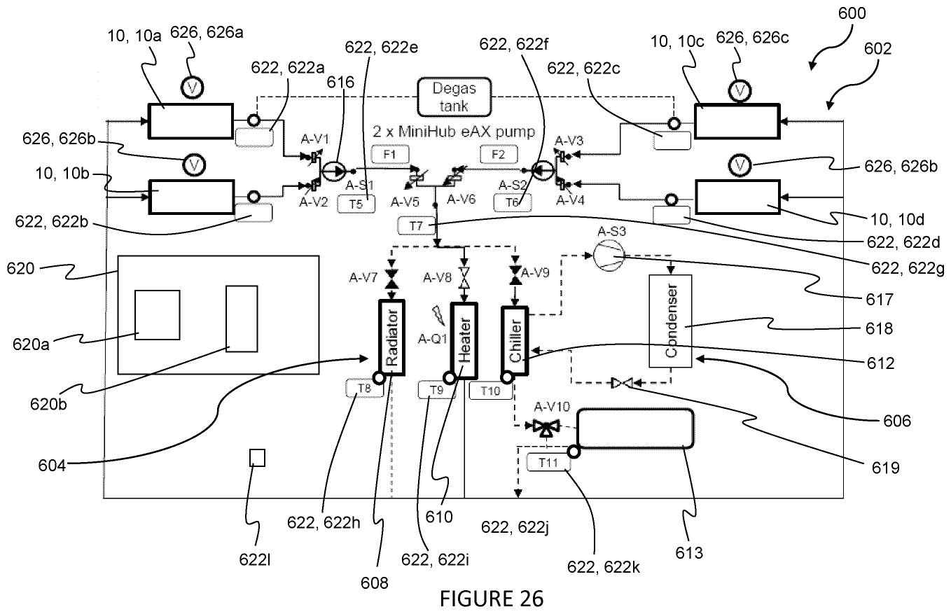

Reference is made to FIG. 26, which shows an example layout of a multi-pack system 600 which includes a plurality of battery packs 10 and a thermal management system 602 therefor. The plurality of battery packs includes a first battery pack 10a, a second battery pack 10b, a third battery pack 10c, and a fourth battery pack 10d. The number of battery packs 10 included in the multi-pack system 600 shown here is but an example. The multi-pack system 600 may include as few as two battery packs 10, three battery packs 10, five battery packs 10 or more (i.e. as many battery packs 10 as are needed for a particular application). The multi-pack system 600 may be said to include therefore a first battery pack 10a and a second battery pack 10b, and may optionally include more battery packs 10.

Each battery pack 10 shown in FIG. 26 (including, accordingly, each of the first and second battery packs 10a and 10b) may be similar to the battery pack 10 shown in FIGS. 2-25.

The thermal management system 602 may include a coolant system 604 which transports coolant through the plurality of battery packs 10, and may further include a refrigerant system 606, which transports refrigerant for cooling the coolant. In the example shown in FIG. 26, the coolant 605 is the cooling fluid in which the cells 503 are immersed. The coolant system 604 may include a radiator 608, a heater 610, a chiller 612, a thermal storage tank 613, a plurality of valves 614, a degas tank 615, and at least one pump 616. The refrigerant system 606 may include a compressor 617, a condenser 618 (and its associated fan), and an expansion valve 619, and passes the refrigerant through the chiller 612 to act as an evaporator. The chiller 612 thus exchanges heat between the coolant and refrigerant.

The radiator 608 may be any suitable radiator as is known for use in electric and in non-electric (e.g. gasoline engine powered) vehicles, and includes a fan to assist in blowing air across the radiator body to promote cooling of the coolant contained in the radiator body, as is known in the art. The heater 610 may be any suitable type of heather, such as, for example an electric heater. For example, the heather 610 may be a PTC heater or any other suitable type of heater.

The thermal storage tank 613 may be a tank that contains a secondary cooling medium 613a, which is a medium that is used to lower the temperature of the coolant in selected emergency situations, such as when there is a risk of thermal runaway in one or more of the battery packs 10. The secondary cooling medium 613a may be any suitable medium, such as a suitable phase change material that can cool the coolant even after the coolant has been cooled using the refrigerant system 606. Examples of a suitable secondary cooling medium 613a will be known to one skilled in the art and will depend on the particular application.

In the example shown, the plurality of valves 614 includes a first coolant valve 614a, a second coolant valve 614b, a third coolant valve 614c, a fourth coolant valve 614d, a fifth coolant valve 614e, a sixth coolant valve 614f, a seventh coolant valve 614g, an eighth coolant valve 614h, a ninth coolant valve 614i, and a tenth coolant valve 614j. The coolant valves 614 may have any suitable structure. The coolant valves 614a-614f may all be remotely controlled valves, which may be two-position valves (movable to an open position and a closed position only), multi-position valves (valves that can move to a plurality of positions include open, closed, and at least one partially open position), and infinitely adjustable valves (which are infinitely adjustable between the open and closed positions). Providing remotely controlled valves for the coolant valves 614a-614f permits the control system for the thermal management system 602 (shown at 620) to control which of the battery packs 10 receives coolant and which do not. Providing infinitely adjustable, or multi-position, remotely controlled valves for the coolant valves 614a-614f permits the control system 620 to control the amount of non-zero flow of coolant that is provided individually for each battery pack 10, based on the cooling requirements for each battery pack 10.

The coolant valves 614g-614i may all be remotely controlled valves, which may be two-position, multi-position, or infinitely adjustable. The coolant valve 614j may be a remotely-controlled, three-way valve (one inlet, two outlets), which may be two-position, multi-position, or infinitely adjustable. The coolant valve 614j permits the control system 620 to select whether to transport coolant to the thermal storage tank 613, or to transport coolant towards the battery packs 10 while bypassing the thermal storage tank 613.

It will be noted that lines in the coolant system 604 and the refrigerant system 606 that are shown as solid lines are lines that contain a flow of coolant or refrigerant as the case may be. Furthermore, the coolant valves 622g, 622h, and 622i are shown as filled in in black when they are closed, and as filled in in white when they are open to permit coolant flow therethrough.

### Control System And Operation

The control system 620 controls operation of the thermal management system 602 and may be separate from or integrated with or partially integrated with another control system for the battery packs 10. The control system 620 includes a processor 620a and a memory 620b and receives signals from a sensor arrangement 621. The sensor arrangement 622 includes at least one sensor in each of the battery packs 10 that sends signals to the control system 620, that are indicative of whether any of the cells in any of the battery packs are at risk of thermal runaway. In the example embodiment shown, the at least one sensor includes a plurality of temperature sensors 622. The temperature sensors 622 may include temperature sensors 622a, 622b, 622c, 622d, 622e, 622f, 622g, 622h, 622i, 622j, 622k, and 622l. The first, second, third and fourth temperature sensors 622a-622d are positioned to send signals to the control system 620 that are indicative of a temperature of each of the plurality of battery packs 10 (and therefore of the first battery pack 10a and a temperature of the second battery pack 10b). The temperature sensor 622k may be referred to as a secondary cooling medium temperature sensor which is positioned to send signals to the control system 620 that are indicative of a temperature of the secondary cooling medium 613a.

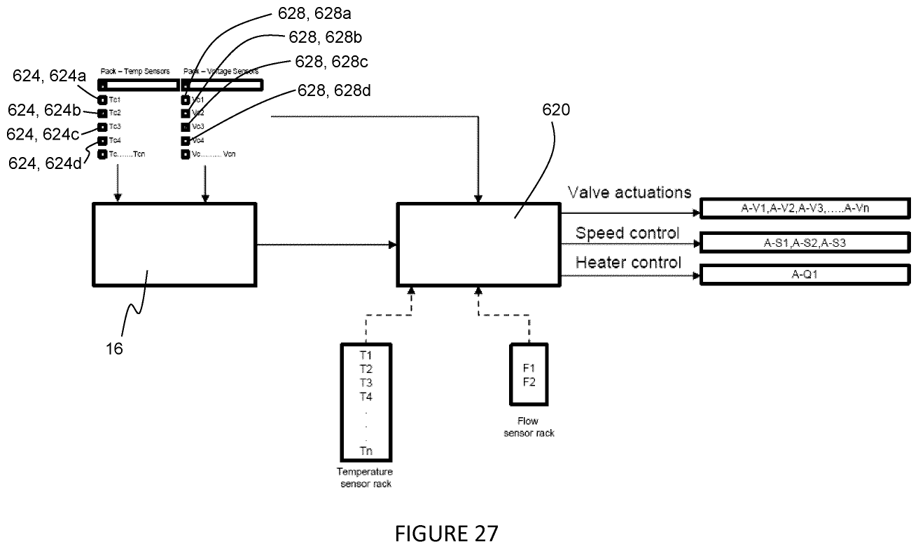

Alternatively or additionally to any other sensors described as part of the sensor arrangement, the sensor arrangement may include a plurality of temperature sensors that are shown schematically in FIG. 27, which are internal to each of the battery packs 10, and some of which are shown at 624 generally and individually at 624a, 624b, 624c, and 624d. These temperature sensors 624 are also positioned to send signals to the control system 620 that are indicative of a temperature of each of the plurality of battery packs 10 (and therefore of the first battery pack 10a and a temperature of the second battery pack 10b), and may be positioned in closer proximity to cells 503 that are at risk of thermal runaway, than the temperature sensors 622. As shown schematically in FIG. 27, the temperature sensors 624 internal to each battery pack may communicate with the battery pack control system 26 for that battery pack 10, and each battery pack control system 26 may then communicate to the control system 620.

Alternatively or additionally to any other sensors described as part of the sensor arrangement, the sensor arrangement may include a plurality of voltage sensors 626, which can send signals to the control system 620, and which are indicative of, among other things, the cooling load represented by each of the battery packs 10. The voltage sensors 626 are shown individually as a first voltage sensor 626a for the first battery pack 10a, a second voltage sensor 626b for the second battery pack 10b, a third voltage sensor 626c for the third battery pack 10c, and a fourth voltage sensor 626d for the fourth battery pack 10d. It will be noted that the signals from the temperature sensors 622a-622d are also indicative of the thermal load represented by each of the battery packs 10. Alternatively or additionally to any other sensors described as part of the sensor arrangement, the sensor arrangement may include a plurality of voltage sensors, that are shown schematically in FIG. 27, which are internal to each of the battery packs 10, and some of which are shown at 628 generally and individually at 628a, 628b, 628c, and 628d. The voltage sensors 628 may incorporate the voltage taps 530 shown in other figures. In general, signals that are indicative of the thermal load represented by the battery pack 10, may be said to be indicative of a cooling load indication value for the battery pack 10.

The sensor arrangement may further include a plurality of flow sensors 630, and shown individually as a first flow sensor 630a and a second flow sensor 630b. Please also note that there could be an individual flow sensor 630 for each battery pack 10.

FIG. 27 shows the control system 620 and its connection schematically to the various sensors described herein.

The sensors described with reference to FIGS. 26-35 have not been drawn with connector lines (apart from FIG. 27) back to the control system 620, so as not to visually clutter the figures. However, it will be understood that the sensors may communicate with the control system 620 in any suitable way, such as by cables, wireless, or by any other suitable means.

The memory 620b contains program code executable by the processor 620a to operate the plurality of valves 622 to increase flow of the cooling fluid (in this example, the coolant) to one of the battery packs 10 and to decrease flow of the cooling fluid (in this example, the coolant) to the other battery packs 10, based on the signals, in order to inhibit thermal runaway in the said one of the battery packs 10. Decreasing flow of the cooling fluid to any battery pack 10 is intended to include stopping flow of coolant to the battery pack 10.

By decreasing flow of the cooling fluid (e.g. the coolant) to the other battery packs 10, the thermal management system 602 is able to increase the flow of cooling fluid to the battery pack 10 determined to be at risk of thermal runaway, and may also be able to provide a colder temperature for the cooling fluid entering the battery pack 10 determined to be at risk of thermal runaway, thereby better inhibiting the thermal runaway from occurring, and from spreading throughout the battery pack 10 determined to be at risk.

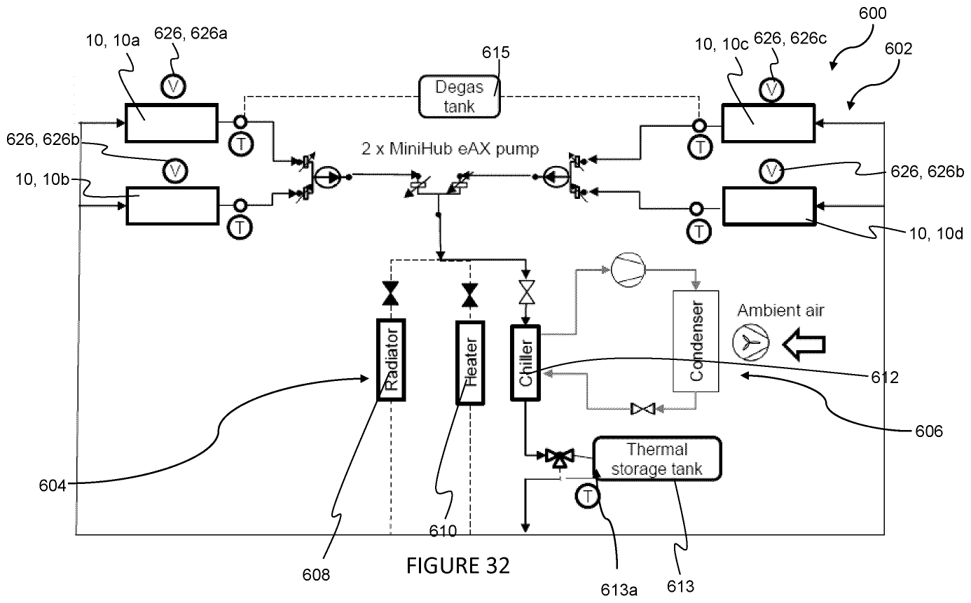

As shown in FIG. 32, which illustrates the thermal management system 602 in a heating mode, in a particular example, the memory contains program code executable by the processor to:

a) determine whether the first battery pack 10a is at risk of thermal runaway based on the signals;

b) determine whether the second battery pack 10b is at risk of thermal runaway based on the signals;

c) operate the plurality of valves 622 to increase flow of the cooling fluid to the first battery pack 10a and to decrease flow of the cooling fluid to the second battery pack 10b based on determining in steps a) and b) that the first battery pack 10a is at risk of thermal runaway and that the second battery pack 10b is not at risk of thermal runaway; and

d) operate the plurality of valves to increase flow of the cooling fluid to the first battery pack 10a and to decrease flow of the cooling fluid to the second battery pack 10b based on determining in steps a) and b) that the first battery pack 10a is at risk of thermal runaway and that the second battery pack 10b is not at risk of thermal runaway.

For example, in an embodiment where the temperature sensor 622a sends signals that show that the temperature of the coolant in the first battery pack 10a is increasing at at least a selected rate, or has increased to a temperature that is more than a selected delta temperature higher than the temperatures of the other battery packs 10, the processor 620a may determine that the first battery pack 10a is at risk of thermal runaway.

By contrast, if the temperature sensor 622a sends signals that show that the temperature of the coolant in the first battery pack 10a is not increasing, or has increased but has done so in lockstep with the temperatures of the other battery packs 10 such that the temperature of the first battery pack 10a is within a selected delta temperature of the temperatures of the other battery packs 10, the processor 620a may determine that the first battery pack 10a is not at risk of thermal runaway.

When sending coolant to whichever battery pack is determined to be at risk of thermal runaway, the control system 620 may operate the refrigerant system 606 in a known manner for refrigerant systems (i.e. to compress the refrigerant in the compressor 617, to condense the refrigerant in the condenser 618, to expand the refrigerant in the expansion valve 619, and to evaporate the refrigerant in the chiller 612, in order to use the refrigerant to cool the coolant flowing through the chiller 612, and to direct the coolant to flow through the chiller 612 and then to whichever battery pack 10 is at risk of thermal runaway.

The memory 620b may include program code executable by the processor during steps c) and d) to:

e) operate the refrigerant system to cool the refrigerant, and

f) control the plurality of valves to direct the coolant through the chiller 612 so as to cool the coolant by the refrigerant in the chiller 612, thereby providing a lower temperature for the coolant than would be provided using the radiator 608, so as to thereby enhance the effectiveness of the coolant at inhibiting thermal runaway.

In embodiments in which the thermal management system 602 includes a thermal storage tank, the memory 620b may include program code executable by the processor during steps c) and d) to:

g) control the plurality of valves to direct the coolant through the thermal storage tank so as to cool the coolant by the secondary cooling medium.

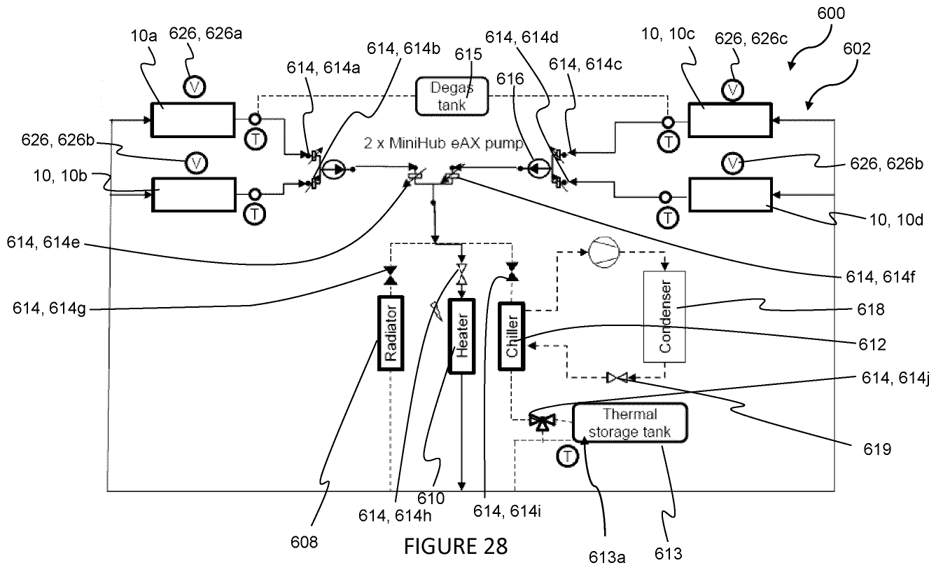

As shown in FIG. 28, which illustrates the thermal management system 602 in a heating mode, the memory 620b may further contain program code executable by the processor 620a to:

h) determine based on the signals whether the temperature of at least one of the first and second battery packs 10 is less than a first threshold battery pack temperature; and

i) control the plurality of valves to direct the coolant through the heater based on the determination in step h) so as to heat the at least one of the battery packs 10 (or in an embodiment one of the first and second battery packs 10a and 10b) to bring the temperature of the at least one of the first and second battery packs 10a and 10b above the first threshold battery pack temperature and into a selected operating temperature range for the at least one of the first and second battery packs 10a and 10b. The first threshold battery pack temperature may be any suitable temperature such as, for example 20 degrees Celsius.

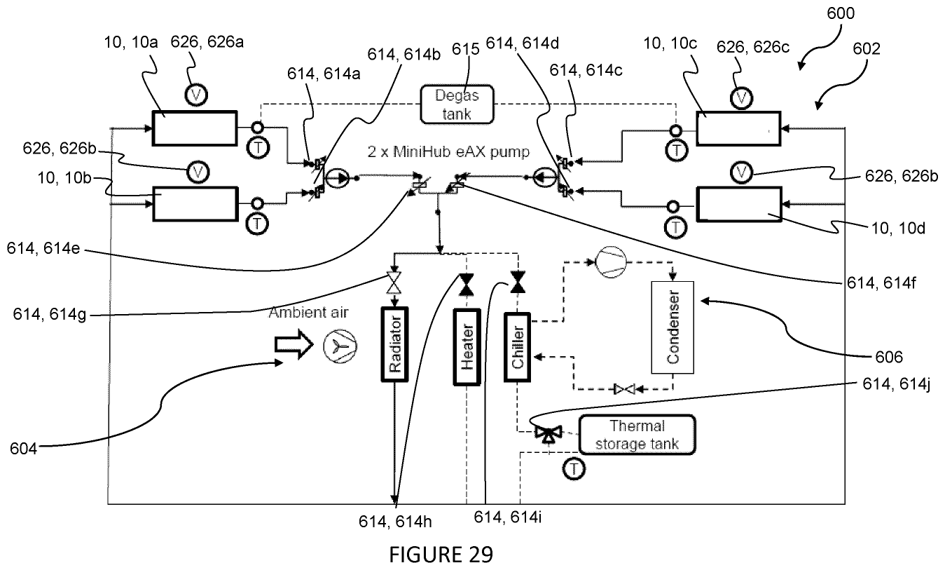

As shown in FIG. 29, which illustrates the thermal management system 602 in a passive cooling mode, in embodiments in which the plurality of temperature sensors 622 are positioned to send signals to the control system that are indicative of an ambient temperature (i.e. include the temperature sensor 6221 which is the ambient temperature sensor), the memory 620 may further contains program code executable by the processor 620a to:

j) determine based on the signals whether the ambient temperature is less than a first threshold ambient temperature;

k) determine whether a cooling load indication value for at least the first and second battery packs (10a and 10b) is below a selected cooling load indication value; and

l) control the plurality of valves 614 to direct the coolant through the radiator 608 based on the determinations in step j) and step k) to maintain the at least the first and second battery packs 10a and 10b below a selected upper threshold battery pack temperature.

The selected upper threshold battery pack temperature may be any suitable temperature such as, for example, about 60 degrees Celsius. The selected cooling load indication value may depend on a number of factors such as the capacity of the radiator, the sensed ambient temperature, the flow capacity of the coolant system 604, and other factors, and can be selected based on the requirements of the application. The first threshold ambient temperature may be any suitable value, such as, for example, 35 degrees Celsius.

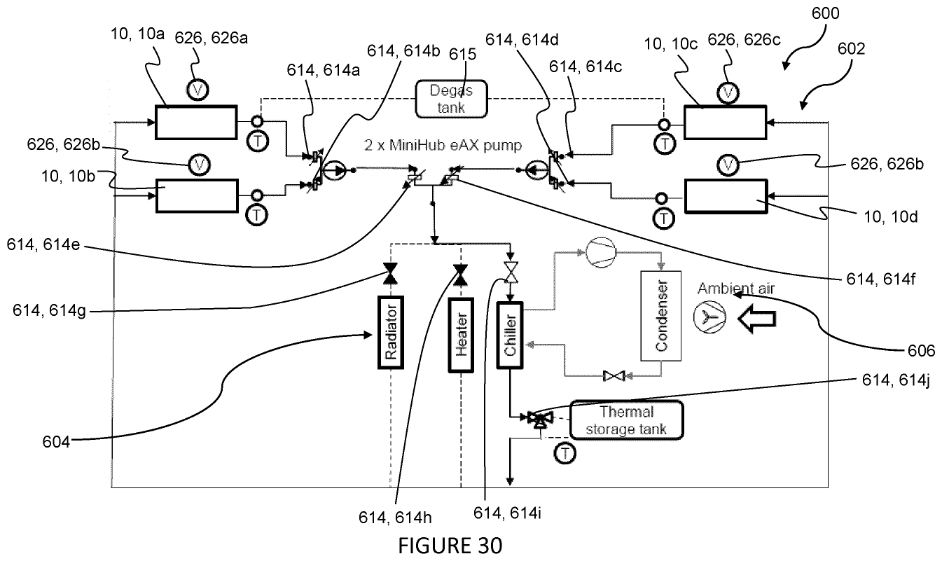

As shown in FIG. 30, which illustrates the thermal management system 602 in an active cooling mode, embodiments in which the plurality of temperature sensors 622 are positioned to send signals to the control system that are indicative of an ambient temperature (i.e. include the temperature sensor 6221 which is the ambient temperature sensor), the memory 620 may further contains program code executable by the processor 620a to:

m) determine based on the signals whether the ambient temperature is above the first threshold ambient temperature and/or whether the cooling load indication value for at least the first and second battery packs 10a and 10b is above the selected cooling load indication value; and

n) operate the refrigerant system 606 and control the plurality of valves 614 to direct the coolant through the chiller 612 based on whether step m) results in a determination that the ambient temperature is above the first threshold ambient temperature and/or a determination that the cooling load indication value for at least the first and second battery packs 10a and 10b is above the selected cooling load indication value, to maintain the at least the first and second battery packs 10a and 10b (or the plurality of battery packs 10) below the selected upper threshold battery pack temperature.

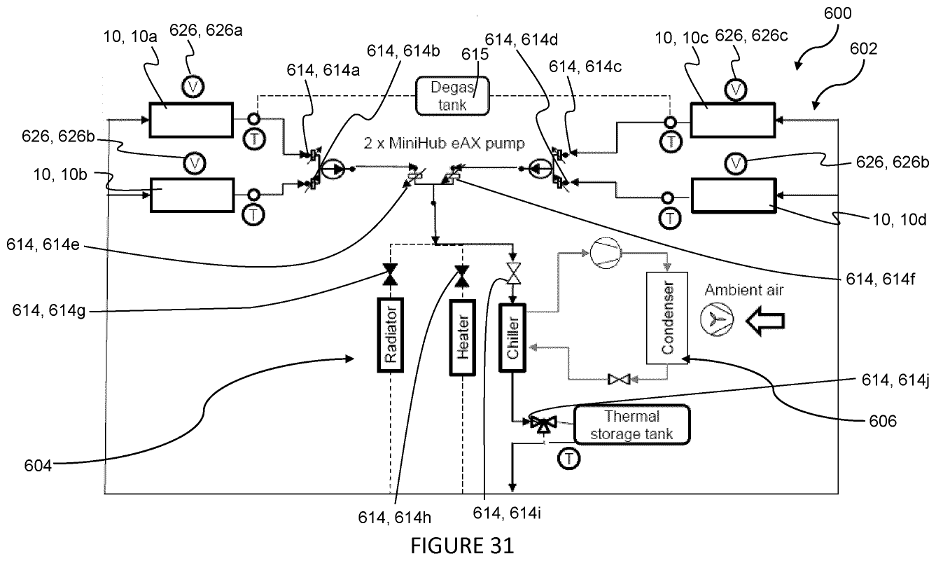

As shown in FIG. 31, which illustrates the thermal management system 602 in secondary cooling medium charging mode, in embodiments in which the sensor arrangement includes the secondary cooling medium temperature sensor 622k which is positioned to send signals to the control system 620 that are indicative of the temperature of the secondary cooling medium 613a, and

wherein the memory further contains program code executable by the processor to:

m) determine based on the signals that the temperature of the secondary cooling medium is above a selected threshold temperature for the secondary cooling medium; and

n) operate the refrigerant system and control the plurality of valves to direct the coolant through the chiller and through the secondary cooling tank, based on the determination in step m) and based on determining in steps a) and b) that the first battery pack is not at risk of thermal runaway and that the second battery pack is not at risk of thermal runaway to maintain the at least the first and second battery packs below the selected upper threshold battery pack temperature.

It will be noted that the valves that are open and closed in FIG. 31 are the same as shown in FIG. 32.

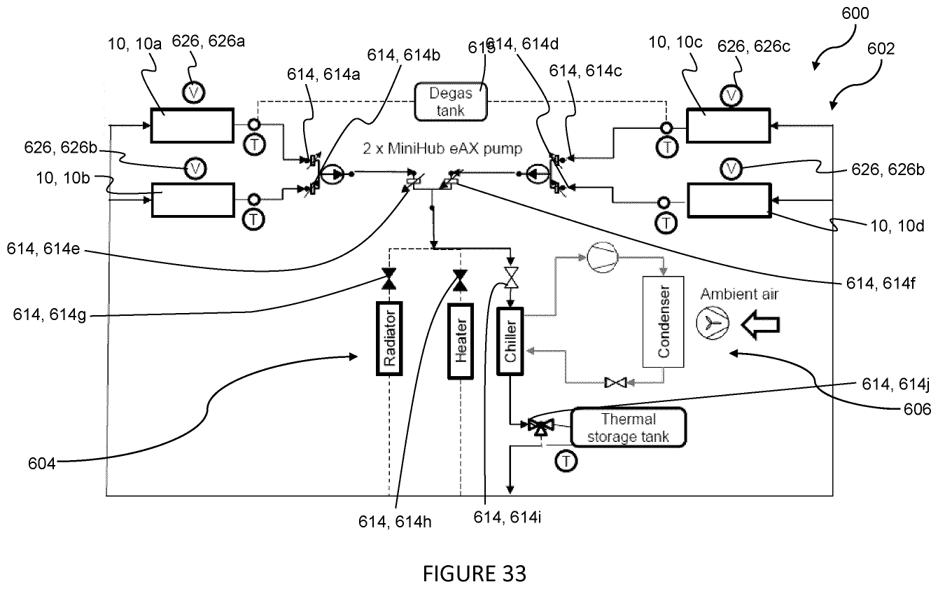

FIG. 33 illustrates the use of the secondary cooling storage tank 613 for cooling the coolant in combination with the chiller 612 during situations where the ambient temperature is determined to be very hot, such that the chiller 612 would not be capable of controlling the temperatures of the battery packs 10 to below the second threshold battery pack temperature (e.g. 60 degrees Celsius), even though the control system 620 does not determine in steps a) and b) that there is a risk of thermal runaway in the first and second battery packs 10a and 10b (or alternatively in all the battery packs 10).

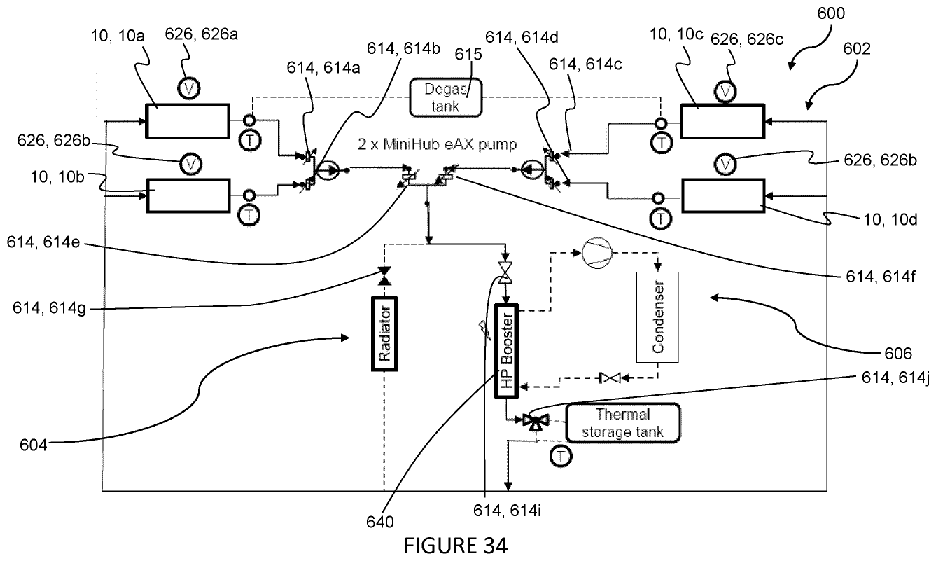

FIG. 34 illustrates an embodiment in which the heater and the chiller are both combined into a single unit, which is a heat pump shown at 640. An example of such a heat pump may be as provided in PCT publication WO2023060352, the contents of which are incorporated fully herein by reference. It will be understood by one skilled in the art that the heat pump 640 may be operated in cooperation with the refrigerant system 606 as needed to heat or to cool the coolant, depending on the needs of the thermal management system 602.

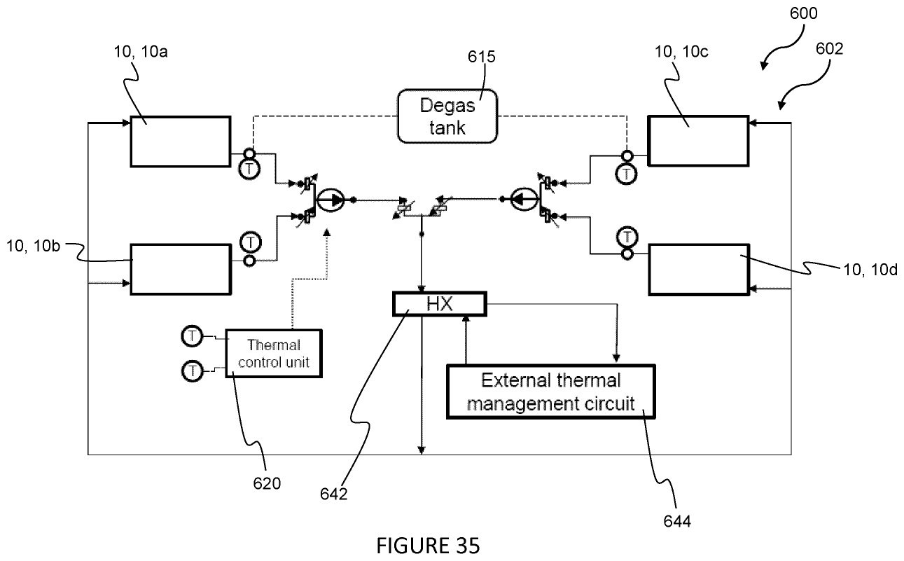

FIG. 35 illustrates yet another embodiment in which the heater and the cooler are both replaced by a heat exchanger shown at 642. The heat exchanger 642 is positioned to carry out heat exchange with an external thermal management system shown at 644. The external thermal management system 644 may be any suitable type of thermal management system, and may be pre-existing prior to installation of the battery packs 10 and the thermal management system 602. The external thermal management system 644 may be capable of heating and cooling the coolant in the heat exchanger 642, so as to carry out temperature control on the battery packs 10 as needed.

### Additional Statements

It will be noted that the steps described herein as being contained within the program code that is stored in memory 620b and is executed by the processor 620a are identified with letters for easier reference to the steps, but the letters identifying the steps are not to be interpreted as restricting the steps to be carried out in the alphabetical order of the identifying letters. Thus, it is not necessary for step b) to be carried out after step a). Furthermore, some steps may be carried out in a different order than the alphabetical order would indicate, as will be apparent to one skilled in the art.

In any case described herein where a memory contains program code executable by a processor to make one or more determinations, and to carry out an action based on the one or more determinations, it will be intended to mean that the program code carries out the action based solely on the said one or more determinations. The program code may in at least some instances carry out the action based on the said one or more determinations, and based additionally on one or more other determinations. For example, it has been noted above that the memory contains program code executable by the processor to: j) determine based on the signals whether the ambient temperature is less than a first threshold ambient temperature; k) determine whether a cooling load indication value for at least the first and second battery packs is below a selected cooling load indication value; and I) control the plurality of valves to direct the coolant through the radiator 608 based on the determinations in step j) and step k) to maintain the at least the first and second battery packs below a selected upper threshold battery pack temperature. It will be noted that the memory also carries out step l) based on a determination in steps a) and b) that there is no risk of thermal runaway.

Those skilled in the art will appreciate that the embodiments disclosed herein can be modified or adapted in various other ways whilst still keeping within the scope of the appended claims.

1-3. (canceled)

4. A module for a battery pack, comprising:
a module housing defining a sealed fluid-holding space for holding a quantity of a cooling fluid;
a plurality of cells positioned in the module housing each of the cells including a positive terminal and a negative terminal;
a bus bar in the fluid-holding space, wherein the bus bar electrically connects the positive terminals on a first subset of cells from the plurality of cells and the negative terminals on a second subset of cells from the plurality of cells;
a voltage tap in engagement with the bus bar, wherein the voltage tap is molded into the housing; and
a module controller that is mounted to an exterior of the module housing, wherein the voltage tap is engaged with the module controller to send signals thereto.

5. (canceled)

6. A battery pack, comprising:
a battery pack housing defining a pair of side walls; and
a plurality of modules positioned in the battery pack housing in a row along the side walls, wherein each of the modules includes a module housing that extends between the side walls;
wherein each of modules contains a first plurality of cells that are all electrically connected to one another, and a second plurality of cells that are all electrically connected to one another, and which are electrically isolated from the first plurality of cells.

7-19. (canceled)

20. A module for a battery pack, comprising:
a module housing including a first module housing member and a second module housing member that is removably connected to the first module housing member at least indirectly;
a plurality of cells positioned in the first module housing member, each of the cells including a positive cell terminal and a negative cell terminal, wherein each of the cells is oriented such that the positive cell terminal faces the second module housing member;
a bus bar that is positioned between the plurality of cells and the second module housing portion and which electrically connects the positive terminals on a first subset of cells from the plurality of cells and the negative terminals on a second subset of cells from the plurality of cells, wherein the bus bar includes a plurality of positive bus bar terminals that are in releasable abutment with the positive cell terminals from the first subset of cells, and a plurality of negative bus bar terminals that are in releasable abutment with the negative cell terminals from the second subset of cells, wherein each of the positive bus bar terminals and/or each of the negative bus bar terminals is supported by a terminal support, wherein the terminal support includes a plurality of bends therein so as to be resiliently flexible so as to resiliently drive releasable engagement between said each of the positive bus bar terminals and/or each of the negative bus bar terminals with the positive cell terminals of the first subset of cells and/or with the negative cell terminals of the second subset of cells.

21. A module as claimed in claim 20, wherein the bus bar is mounted to the second module housing portion so as to be removed automatically from the first and second subsets of cells by removal of the second module housing portion from the first module housing portion.

22. A module as claimed in claim 20, wherein each of the positive and negative bus bar terminals has a contact surface for contacting one of the positive and negative cell terminals of one of the first and second subsets of cells, wherein the contact surface is textured to define a plurality of contact surface portions, and a plurality of recesses between adjacent ones of the contact surface portions, wherein the recesses have a depth from the contact surface portions of at least 0.2 millimeters and a width of at least 0.2 millimeters.

23. A module as claimed in claim 20, further comprising a voltage tap in engagement with the bus bar, wherein the voltage tap is molded into the module housing and extends through the housing from an interior of the module housing; and
a module controller that is mounted to an exterior of the module housing, wherein the voltage tap is engaged with the module controller to send signals thereto.

24. A module as claimed in claim 20, wherein the positive cell terminals of the plurality of cells are supported by a plurality of struts, and wherein said each of the positive bus bar terminals and/or each of the negative bus bar terminals is said each of the positive bus bar terminals, so as to resiliently drive releasable engagement between said each of the positive bus bar terminals with the positive cell terminals of the first subset of cells.

25. A module as claimed in claim 24, wherein the negative bus bar terminals are in direct abutment with a support surface of the second module housing member.

26. A module as claimed in claim 20, further comprising at least one cell biasing member positioned in engagement with all of one of the first and second subsets of cells separately from the bus bar, wherein the at least one cell biasing member urges said all of one of the first and second subsets of cells towards the bus bar.

27. A module as claimed in claim 26, wherein which electrically connects in parallel to the negative terminals of said all of one of the first and second subsets of cells.

28. A module as claimed in claim 20, wherein the module housing defines a cell chamber for holding the plurality of cells and a quantity of a cooling fluid for cooling the plurality of cells during operation of the module.

29. A module as claimed in claim 20, wherein the negative cell terminal on each of the cells of the plurality of cells faces towards the second module housing member.

30. A battery pack as claimed in claim 6, wherein each module of the plurality of modules a first module end terminal of the first plurality of cells, and a second module end terminal of the second plurality of cells, and wherein, for a first module of the plurality of modules, the first module end terminal is a negative terminal for an entirety of the entire battery pack and the second module end terminal is a positive terminal of the entirety of the battery pack.

31. A battery pack as claimed in claim 6, wherein for each module of the plurality of modules except a last module of the plurality of modules, the first module end terminal of the module is connected in series to the first module end terminal of a successive module from the plurality of modules, and the second module end terminal of the module is connected in series to the second module end terminal of the successive module from the plurality of modules, and wherein, for the last module of the plurality of modules, the first module end terminal is connected to the second module end terminal.

32. A battery pack as claimed in claim 6, wherein the module housing for each module of the plurality of modules includes a divider wall that separates the first and second pluralities of cells from one another.

33. A battery pack as claimed in claim 32, wherein the module housing includes a first module housing portion and a second module housing portion, wherein the second module housing portion is a lower tub, and the first module housing portion forms an upper lid.

34. A battery pack as claimed in claim 33, wherein the module housing further includes a cell-holder plate that is clamped between the first and second module housing members, wherein the cell-holder plate includes a plurality of cell-holding apertures sized to snugly hold the first plurality of cells and the second plurality of cells wherein the divider wall includes a first portion that is directly formed in the second module housing portion, and a second portion that is part of the cell-holder plate.

35. A module for a battery pack as claimed in claim 4, wherein the bus bar has a bus-bar voltage tap receiving aperture and the module controller has a controller voltage tap receiving aperture, and wherein the voltage tap has a first end that is in a press-fit engagement with the bus-bar voltage tap receiving aperture and a second end that is in a press-fit engagement with the controller voltage tap receiving aperture.

36. A module for a battery pack as claimed in claim 35, wherein the first end of the voltage tap includes a clip member that holds the voltage tap to the bus bar.

37. A module for a battery pack as claimed in claim 36, wherein the bus bar is held to the module housing by the clip member.
